(19) United States
(12) Patent Application Publication
(10) Pub. No.: US 2026/0222615 A1
(43) Pub. Date: Jul. 30, 2026

(54) ENCODING AND DECODING METHODS, AND STORAGE MEDIUM

(71) Applicant: GUANGDONG OPPO MOBILE TELECOMMUNICATIONS CORP., LTD., Dongguan (CN)

(72) Inventor: Honglian WEI, Dongguan (CN)

(21) Appl. No.: 19/644,854

(22) Filed: Apr. 10, 2026

Related U.S. Application Data
(63) Continuation of application No. PCT/CN2023/124376, filed on Oct. 12, 2023.

(51) Int. Cl. H04N 19/54; H04N 19/105; H04N 19/159; H04N 19/172; H04N 19/196; H04N 19/70

(52) U.S. Cl. CPC H04N 19/54; H04N 19/105; H04N 19/159; H04N 19/172; H04N 19/196; H04N 19/70

(57) ABSTRACT

A decoding method includes the following. A bitstream is parsed to determine first picture-level syntax identification information corresponding to a base mesh of a current picture. When the first picture-level syntax identification information indicates inter decoding, dimension syntax identification information corresponding to each of multiple coordinate dimensions for a vertex in the base mesh is determined by parsing the bitstream, where the dimension syntax identification information corresponding to each coordinate dimension indicates a motion-vector prediction mode corresponding to the coordinate dimension. Based on the dimension syntax identification information corresponding to each of the multiple coordinate dimensions, a motion-vector decoded value corresponding to each coordinate dimension for the vertex is determined, thereby determining motion-vector decoded information corresponding to the vertex.

### CROSS-REFERENCE TO RELATED APPLICATION(S)

This application is a continuation of International Application No. PCT/CN2023/124376, filed Oct. 12, 2023, the entire disclosure of which is incorporated herein by reference.

### TECHNICAL FIELD

Embodiments of the present disclosure relate to the field of dynamic mesh coding technologies, and in particular, to encoding and decoding methods, and a storage medium.

### BACKGROUND

In the standard reference software for Dynamic Mesh Coding (DMC) provided by the Moving Picture Experts Group (MPEG), when inter encoding is performed on a base mesh of a current picture, motion vectors of vertices in the base mesh are usually encoded. At the decoder side, by decoding the motion vectors of the vertices in the base mesh, in combination with connectivity information of a base mesh of a reference picture corresponding to the current picture, the base mesh corresponding to the current picture is reconstructed.

However, the current method for determining a coding mode for a motion vector is not yet perfect, resulting in a high coding cost for the motion vector, thereby reducing the coding efficiency of the base mesh and consequently decreasing the coding performance of DMC.

### SUMMARY

In a first aspect, an embodiment of the present disclosure provides a decoding method applied to a decoder, where the method includes the following. A bitstream is parsed to determine first picture-level syntax identification information corresponding to a base mesh of a current picture. When the first picture-level syntax identification information indicates inter decoding, dimension syntax identification information corresponding to each of multiple coordinate dimensions for a vertex in the base mesh is determined by parsing the bitstream, where the dimension syntax identification information corresponding to each coordinate dimension indicates a motion-vector prediction mode corresponding to the coordinate dimension. Based on the dimension syntax identification information corresponding to each of the multiple coordinate dimensions, a motion-vector decoded value corresponding to each coordinate dimension for the vertex is determined, thereby determining motion-vector decoded information corresponding to the vertex.

In a second aspect, an embodiment of the present disclosure provides an encoding method applied to an encoder, where the method includes the following. A base mesh of a current picture and a motion vector corresponding to each coordinate dimension for a vertex in the base mesh are determined. When performing inter encoding on the base mesh, encoding cost estimation is performed for at least one mode based on the motion vector corresponding to each coordinate dimension for the vertex, to determine at least one encoding cost for each coordinate dimension. According to the at least one encoding cost, dimension syntax identification information corresponding to each coordinate dimension for the vertex is determined, where the dimension syntax identification information for each coordinate dimension indicates a motion-vector prediction mode corresponding to the coordinate dimension.

In a third aspect, an embodiment of the present disclosure provides a non-transitory computer-readable storage medium storing a computer program and a bitstream. The computer program, when executed by a processor, causes the processor to generate the bitstream according to the encoding method of the second aspect.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

FIG. 1A is a first schematic diagram of a three-dimensional mesh picture;

FIG. 1B is a partially enlarged schematic diagram of a three-dimensional mesh picture;

FIG. 2 is a schematic diagram illustrating connection of a three-dimensional mesh;

FIG. 3A is a second schematic diagram of a three-dimensional mesh picture;

FIG. 3B is a schematic diagram of a mesh data storage format;

FIG. 3C is a schematic diagram of attributes of a three-dimensional mesh picture;

FIG. 4 is a schematic diagram of a composition of an overall mesh coding framework;

FIG. 5A is a schematic diagram illustrating preprocessing of a two-dimensional curve;

FIG. 5B is a schematic diagram illustrating generation of displacement coefficients;

FIG. 6A is a first schematic diagram illustrating quantization processing of mesh geometric position information;

FIG. 6B is a second schematic diagram illustrating quantization processing of mesh geometric position information;

FIG. 7A is a schematic diagram illustrating coding of connectivity of triangular faces;

FIG. 7B is a schematic diagram illustrating coding of geometric position information;

FIG. 7C is a schematic diagram illustrating coding of texture coordinates;

FIG. 8 is a schematic diagram illustrating a basic principle of displacement coefficients;

FIG. 9 is a schematic diagram illustrating coding of displacement coefficients mapped to a two-dimensional picture;

FIG. 10 is a schematic diagram illustrating coding of inter geometric position information;

FIG. 11A is a schematic diagram of a composition of an intra encoding framework;

FIG. 11B is a schematic diagram of a composition of an inter decoding framework;

FIG. 12A is a schematic diagram of a composition of an intra decoding framework;

FIG. 12B is a schematic diagram of a composition of an inter decoding framework;

FIG. 13 is a schematic diagram of a network architecture for coding according to an embodiment of the present disclosure;

FIG. 14 is a first schematic flowchart of an encoding method according to an embodiment of the present disclosure;

FIG. 15 is a second schematic flowchart of an encoding method according to an embodiment of the present disclosure;

FIG. 16A is a schematic diagram of connectivity of a reference base mesh of a reference picture according to an embodiment of the present disclosure;

FIG. 16B is a schematic diagram of connectivity of a base mesh of a current picture according to an embodiment of the present disclosure;

FIG. 17 is a third schematic flowchart of an encoding method according to an embodiment of the present disclosure;

FIG. 18 is a schematic flowchart of a decoding method according to an embodiment of the present disclosure;

FIG. 19 is a schematic diagram of a composition structure of an encoder according to an embodiment of the present disclosure;

FIG. 20 is a schematic diagram of a specific hardware structure of an encoder according to an embodiment of the present disclosure;

FIG. 21 is a schematic diagram of a composition structure of a decoder according to an embodiment of the present disclosure;

FIG. 22 is a schematic diagram of a specific hardware structure of a decoder according to an embodiment of the present disclosure;

FIG. 23 is a schematic diagram of a composition structure of a coding system according to an embodiment of the present disclosure.

### DETAILED DESCRIPTION

In order to understand features and technical content of embodiments of the present disclosure in more detail, the embodiments of the present disclosure will be described in detail below with reference to the accompanying drawings. The accompanying drawings are only for reference and description purposes and are not intended to limit the embodiments of the present disclosure.

Unless otherwise defined, all technical and scientific terms used herein have the same meaning as commonly understood by one of ordinary skill in the art to which this disclosure belongs. The terms used herein are only for the purpose of describing the embodiments of the present disclosure and are not intended to limit the present disclosure.

In the following description, reference is made to “some embodiments”, which describe a subset of all possible embodiments, but it is understood that “some embodiments” may be the same subset or different subsets of all possible embodiments and may be combined with each other without conflict.

It should also be noted that the terms “first/second/third” involved in the embodiments of the present disclosure are only used to distinguish similar objects and do not represent a specific ordering of objects. It can be understood that “first/second/third” may be interchanged to a specific order or sequence where permitted, so that the embodiments of the present disclosure described herein can be implemented in an order other than those illustrated or described herein.

It should be noted that decoding and synthesizing bitstreams in different data formats may be allowed in the same video scene. The data formats may include at least a picture format, a point cloud format, and a mesh format. In this way, real-time immersive video interactive services can be provided for multiple data formats (e.g., mesh, point cloud, picture, etc.) from different sources.

In the embodiments of the present disclosure, the data format-based method may allow independent processing at the bitstream level of the data format. That is, like tiles or slices in video coding, different data formats in the scenario can be encoded independently, so that independent encoding and decoding can be performed based on the data format.

Generally speaking, a keyframe-based representation method is used for three-dimensional animation content, that is, each frame is a static mesh. Static meshes at different times have the same topology and different geometric structures. However, the data volume of three-dimensional dynamic meshes based on keyframe representation is particularly large. Therefore, the challenges of effective storage, transmission, and rendering have become obstacles for the development of 3D dynamic meshes. In addition, for different user terminals (computers, notebooks, portable devices, mobile phones), spatial scalability of the mesh needs to be supported; for different mesh bandwidths (broadband, narrowband, wireless), quality scalability of the mesh needs to be supported. Therefore, compression of the three-dimensional dynamic mesh is a very critical issue.

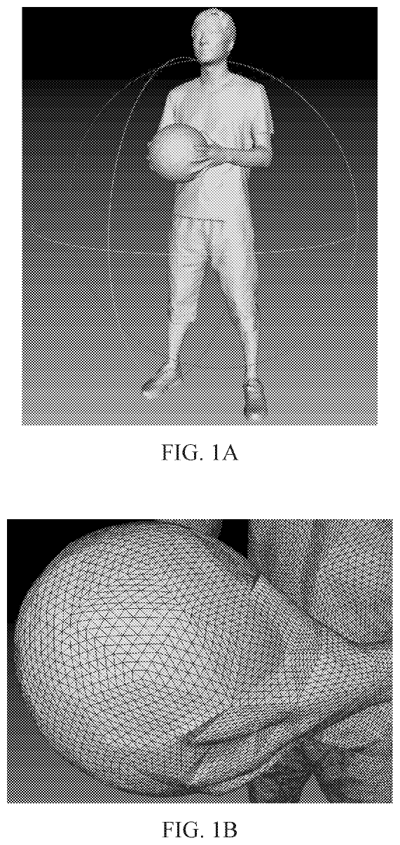

A three-dimensional mesh is a three-dimensional object surface composed of countless polygons in space. Polygons are composed of vertices and edges. FIG. 1A illustrates a three-dimensional mesh picture, and FIG. 1B illustrates a partially enlarged schematic diagram of the three-dimensional mesh picture. As can be seen from FIG. 1A and FIG. 1B, the mesh surface is composed of closed polygons.

In a two-dimensional picture, each pixel has information expression, and the distribution is regular, so there is no need to additionally record position information of pixels. However, in a three-dimensional mesh, the distribution of vertices in three-dimensional space is random and irregular, and the composition of polygons needs to be additionally specified. Therefore, it is necessary to record the position of each vertex in space and the connectivity information of each polygon to fully express a mesh picture. As illustrated in FIG. 2, with the same number of vertices and the same vertex positions, the formed surfaces are completely different due to different connectivity.

In addition to the above information, since three-dimensional mesh pictures are usually encoded using existing two-dimensional picture/video coding methods, it is necessary to convert the three-dimensional mesh from three-dimensional space to a two-dimensional picture. UV coordinates define this conversion process.

Similar to two-dimensional pictures, each position in the acquisition process may have corresponding attribute information, usually RGB color values, which reflect the color of the object. For three-dimensional meshes, in addition to colors, the attribute information corresponding to each vertex usually includes a reflectance value, which reflects the surface material of the object. The attribute information of the three-dimensional mesh is stored through a two-dimensional picture, and the mapping from two dimensions to three dimensions is specified by UV coordinates.

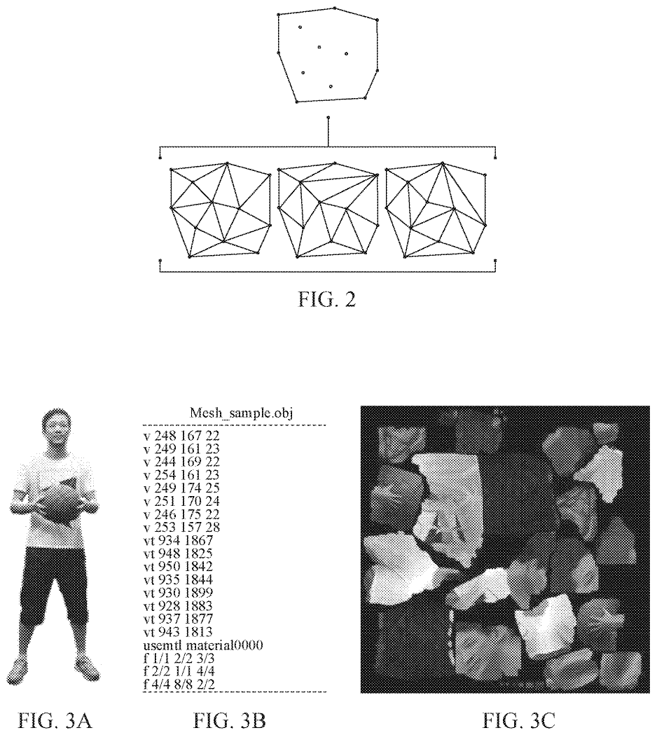

Therefore, three-dimensional mesh data usually includes three-dimensional geometric position information (x, y, z), geometric connectivity, UV coordinates, and attribute maps. FIG. 3A is a three-dimensional mesh picture. FIG. 3B illustrates a storage format of mesh data, which includes three-dimensional geometric position information, UV coordinates, and connectivity information. FIG. 3C is a corresponding attribute diagram.

Current three-dimensional dynamic mesh compression methods include space-time prediction-based methods, which improve compression efficiency by eliminating spatial and temporal correlations; Principal Components Analysis (PCA)-based techniques, which project in an eigenvector space to concentrate energy; and wavelet-based methods, which support spatial scalability and quality scalability.

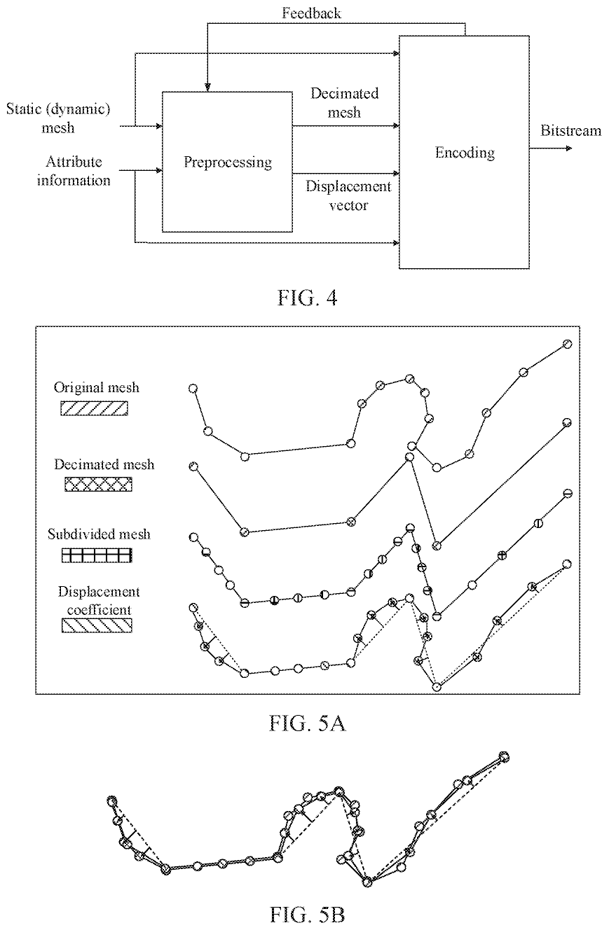

It should be noted that in the Dynamic Mesh Coding provided by the Moving Picture Experts Group (MPEG), FIG. 4 is a schematic diagram of an overall mesh coding framework, FIG. 5A is a schematic diagram illustrating preprocessing of a two-dimensional curve, and FIG. 5B is a schematic diagram illustrating generation of displacement coefficients. The preprocessing process of a three-dimensional mesh can be analogized similarly. At the encoding end, two parts are mainly involved: Pre-processing and Encoder. First, a base mesh and displacement coefficients are generated through preprocessing. The preprocessing process includes the following. First, an original mesh is downsampled to generate a decimated mesh with a greatly reduced number of vertices, or referred to as a base mesh. Then, the base mesh is subdivided, and new vertices are generated through an algorithm and inserted on the edges of the base mesh to obtain a subdivided mesh. Finally, for each vertex in the subdivided mesh, a vertex nearest to that vertex is found in the original mesh; a vector between the vertex in the subdivided mesh and the nearest vertex in the original mesh is referred to as displacement coefficient. Since the subdivided mesh can be automatically generated at the encoding and decoding ends as long as the subdivision algorithm and the number of subdivision iterations are determined, after preprocessing, the original mesh only needs to be represented as the simple base mesh and a series of displacement coefficients, which can greatly reduce the amount of data without affecting reconstruction at the decoding end.

Video-based Dynamic Mesh Coding (V-DMC) mainly involves geometric position information coding and attribute information coding. Exemplarily, each frame file of a sequence basketball_player includes two files: basketball_player_fr0001_qp12_qt12.obj and basketball_player_fr0002.png. In the files, basketball_player_fr0001_qp12_qt12.obj contains four types of information: geometric position information (x, y, z), connectivity of triangular faces for geometric position information, texture coordinates (u, v), and connectivity of texture coordinates; basketball_player_fr0002.png represents texture attribute information of the current picture. In the current V-DMC encoder, geometric position information is jointly encoded using a Dynamic Range Arithmetic Coding (DRACO) encoder and a video encoder (Video Codec), and texture information is directly encoded using the Video Codec. The Video Codec may include H.264/Advanced Video Coding (AVC), H.265/High Efficiency Video Coding (HEVC), H.266/Versatile Video Coding (VVC/VV-enC), etc. In the following, the coding of mesh geometric information will be introduced in detail.

The coding of geometric information can be divided into: coding of position information (geometric position information and texture position information) and coding of connectivity (connectivity of triangular faces for geometric position information, connectivity for texture position information). The current V-DMC coding mainly has two encoding test conditions: intra coding and inter coding (low delay, currently no RA test environment).

### (I) Intra Coding for Geometric Information.

### 1. Mesh Preprocessing.

a) As illustrated in FIG. 5A and FIG. 5B, the two-dimensional connectivity is taken as an example. The connectivity of the original mesh contains a large number of points. Before encoding the mesh geometric information, quantization or simplification of the mesh geometric information is first performed, and finally a corresponding decimated mesh is obtained as a base mesh.

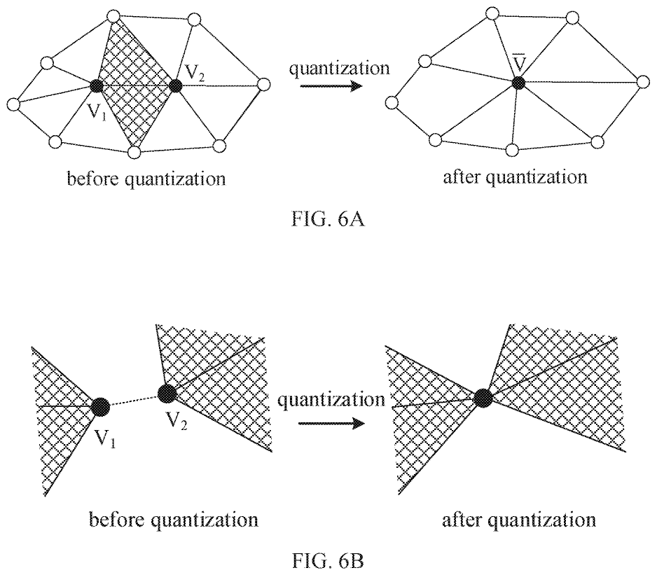

b) As illustrated in FIG. 6A and FIG. 6B, quantization processing of the mesh is performed based on triangular face coordinates. According to the connectivity between quantized points, the quantization processing involves the following two cases:

If two vertices share an edge, i.e., two vertices belonging to one edge before quantization, then after quantization, all triangular faces connected to the two vertices need to be connected together. As illustrated in FIG. 6A, previous triangular faces disappear.

Otherwise, if two vertices do not share an edge, i.e., two vertices not belonging to one edge, then after quantization, only the boundaries of the two vertices need to be merged. As illustrated in FIG. 6B, the number of triangular faces does not change.

c) Throughout the quantization processing of the mesh based on triangular face coordinates, the core issue is how to obtain the best vertices based on the previous vertex coordinates. Currently, in V-DMC, the best quantized point is obtained among the following four modes. Assuming the vertex distribution before quantization is V1 and V2, and the vertex coordinates after quantization are V′, the following exist: V1, V2, (V1+V2)/2, and Q−1 (V1+V2), where Q is a quantization matrix corresponding to the V1 and V2 vertex coordinates. Finally, the optimal quantized point is selected based on a distortion measure D for quantization.

### 2. Base Mesh Coding.

a) After obtaining the Base mesh, the DRACO encoder is used to encode the geometric information of the Base mesh. The geometric information mainly includes: geometric position information and connectivity of the geometric position information. The entire DRACO encoding process is as follows: first, the encoding of connectivity is completed, then the geometric position information of points is encoded based on the connectivity of geometric positions, and finally, texture position information is encoded based on the connectivity and the geometric position information.

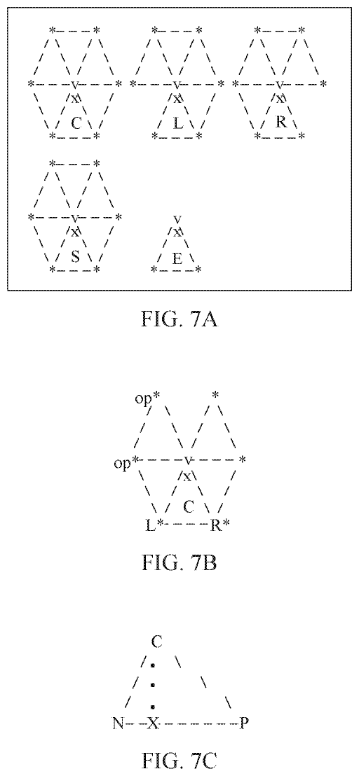

b) Encoding of connectivity. DRACO adopts the “EdgebreakerCoding” scheme for encoding mesh connectivity. See FIG. 7A for details. In FIG. 7A, v represents the current vertex. Before encoding the connectivity of the mesh, vertices of the mesh are divided into five types: C, L, R, S, E. The physical meaning of each symbol is as follows:
C: None of the triangular faces connected to the current vertex have been encoded;
L: The triangular face to the left of the current vertex has been encoded;
R: The triangular face to the right of the current vertex has been encoded;
S: Neither the left nor the right triangular face connected to the current vertex has been encoded;
E: Both the left and right triangular faces connected to the current vertex have been encoded.

Finally, according to a certain order, the type of each vertex and the processing order of the vertices are encoded. The decoding end restores the geometric connectivity of the mesh according to the processing order of the vertices and the vertex types.

c) Coding of geometric position information. After completing the encoding of vertex connectivity, predictive encoding of the geometric position information of each vertex is performed based on the vertex connectivity. The predictive encoding adopts the “Parallelograms algorithm”, as specifically illustrated in FIG. 7B. Simple linear fitting is performed using three adjacent vertices of the current vertex to be encoded: the left vertex, the right vertex, and the opposite vertex:

$${pred}_{pos} = ( left + right ) - opposite \qquad ( 1 )$$

d) After completing the coding of the vertex connectivity and geometric position information, based on the decoding and reconstruction of these two information, predictive encoding of texture coordinates is performed, as specifically illustrated in FIG. 7C. Similarly, assuming the current vertex is C, the left and right vertices of the current vertex can be obtained according to the vertex connectivity. Then, the texture coordinates of the left and right vertices are used to perform predictive encoding on the texture coordinates of the current vertex C.

### 3. Displacement Coefficient Coding.

a) Firstly, after completing the encoding and reconstruction of the Base mesh, a certain partitioning algorithm is used to partition the Base mesh to obtain an initially reconstructed mesh. Specifically, as illustrated in the curve corresponding to the subdivided mesh in FIG. 5A, by using simple linear interpolation, the subdivided mesh (also referred to as an “initial mesh”) is obtained. The coordinates of the newly inserted point are obtained by linear interpolation based on the two vertices on the current boundary:

$${pos}_{new} = \frac{( {pos}_{1} + {pos}_{2} )}{2} \qquad ( 2 )$$

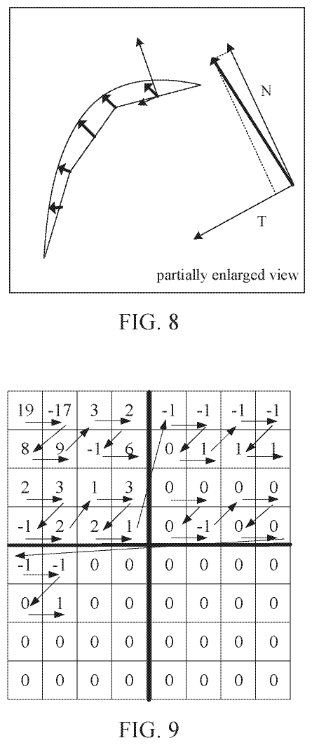

b) Secondly, the error Delta between vertices in the subdivided mesh after partitioning and the original mesh is calculated. The error Delta can be a point error in the world coordinate system. Finally, the Displacement (i.e., displacement coefficient) of each vertex is calculated using the error Delta of each vertex and the normal vector Norm of each vertex, as specifically illustrated in FIG. 8. In FIG. 8, the bold solid line represents the error Delta, and N and T represent the normal vector Norm. In this case, the specific calculation method is as follows:

$$Displacement = Delta \times Norm \qquad ( 3 )$$

c) After calculating the Displacement for each vertex, a lifting transform can be used to transform residual coefficients from the spatial domain into the frequency domain, thus obtaining corresponding frequency domain residual coefficients.

d) Finally, a coefficient packing algorithm is used to map the frequency domain residual coefficients of each vertex onto a two-dimensional picture in a certain order. In the current V-DMC, the Morton code order is used for arrangement, as specifically illustrated in FIG. 9.

e) Finally, a traditional Video Codec is used to encode the two-dimensional picture.

### 4. Recoloring.

Recoloring is an algorithm at the encoding end. After completing the reconstruction of geometric information at the encoding end, the original geometric information, original texture attribute information, and the reconstructed mesh geometric information are used to recolor the texture attribute information of the reconstructed mesh.

### (II) Inter Coding for Geometric Information.

a) Similar to the above coding, geometric information includes geometric position information and connectivity of the geometric position information. However, it should be noted here that for inter coding of geometric position information, only the geometric position information (x, y, z) of the current Base mesh needs to be encoded, and connectivity and texture position information (u, v) do not need to be encoded. The specific reason is that if the current picture can be inter-coded, then at the encoding end, the Base mesh of the reference picture of the current picture will be used to obtain the mesh information of the current picture. Therefore, the current picture and the reference picture have the same connectivity and uv texture coordinates, with only the geometric position information being different.

b) Based on a), it can be known that only the geometric position information has an error between the current picture and the reference picture. Therefore, the current V-DMC performs predictive encoding on the geometric position information of the current picture.

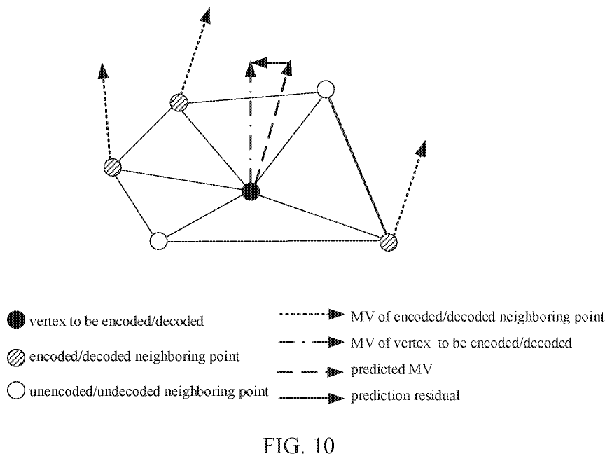

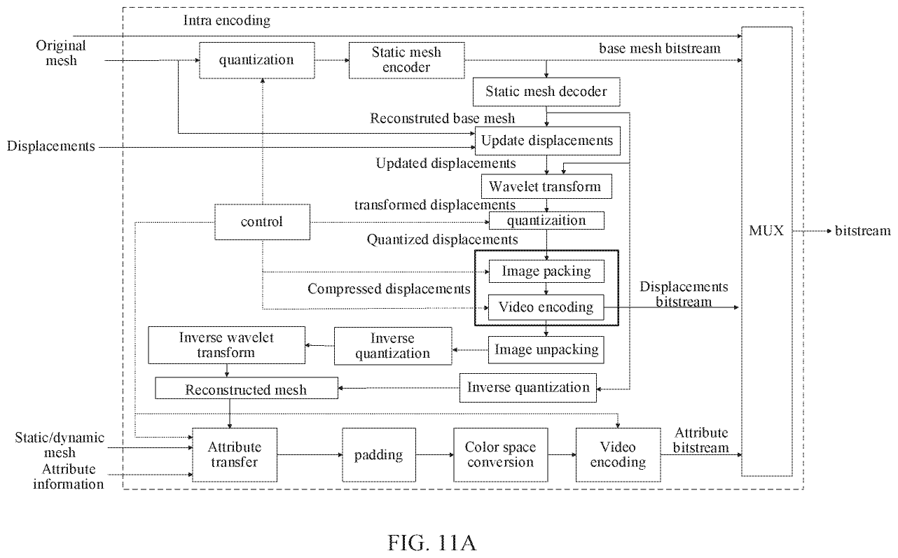

As specifically illustrated in FIG. 10, the black point is the point to be encoded. A prediction point corresponding to the current point in the reference picture (similar to the co-located block in video coding) is used. Then, the motion vector (MV) of the current point is predictively encoded using a neighborhood point of the current point (MV of already encoded vertex). Specifically, assuming the coordinate of the current point is pos, and the coordinate of the co-located point is Predₚₒₛ, then the MV of the current point is calculated as:

$$MV = Pos - {Pred}_{pos} \qquad ( 4 )$$

Currently, there are two prediction coding modes in V-DMC:
i. Directly encoding the MV of the current point;
ii. Predictively encoding the MV of the current point using the neighborhood.

At the encoding end, a rate-distortion optimization algorithm is used to obtain the best coding mode for each coding group (CG). The current V-DMC sets the maximum number of points per CG to 16.

Coding of texture attribute information: Currently, the V-DMC encodes texture attribute information by directly using a video codec, for example: AVC, HEVC, VVC, or VV-enC.

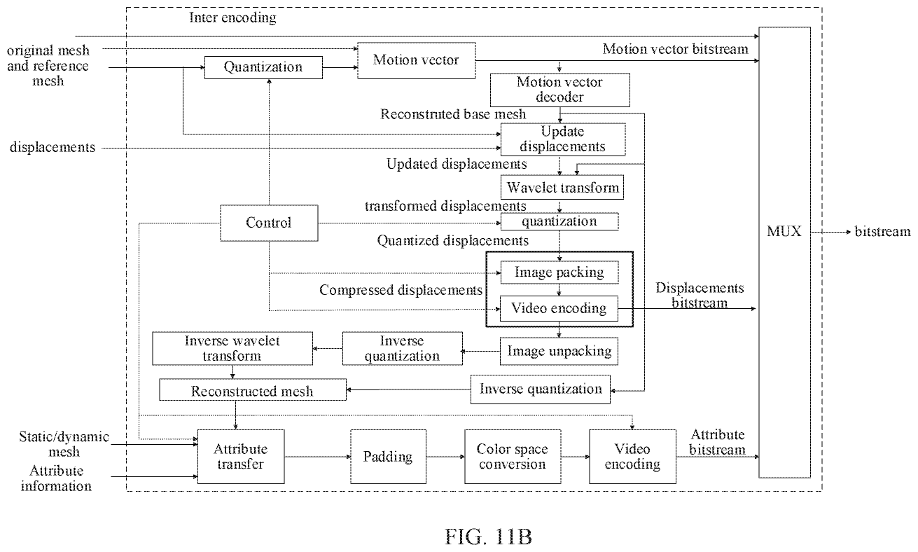

FIG. 11A is a schematic diagram of a framework of an intra encoder. As illustrated in FIG. 11A, in the intra encoder, a common static mesh encoder can be used to encode the base mesh, generating a compressed base mesh bitstream. Next, a reconstructed base mesh is used to update the displacement coefficients (Update Displacements). Wavelet transform and quantization are performed on the updated displacement coefficients to obtain displacement coefficients. These are then packed into a picture/video (Picture Packing, Video Packing) and encoded using HEVC to generate a compressed displacements bitstream. For attribute map encoding, first, the attribute map is transformed according to the difference between the reconstructed geometric information and the original geometric information (Texture Transfer), then it is padded, packed (Video Packing), and encoded with a video encoder to form a compressed attribute bitstream.

FIG. 11B is a schematic diagram of a framework of an inter encoder. As illustrated in FIG. 11B, the flow of the inter encoder is roughly the same as that of the intra encoder, but the inter encoder does not directly encode the base mesh. Instead, the inter encoder encodes the motion vector MV between the base mesh of the current picture and the base mesh of the reference picture, and generates a corresponding motion vector bitstream (compressed motion bitstream).

Correspondingly, during the decoding process, the decoder can also be divided into an intra decoder and an inter decoder, according to the different types of frames it processes, which are used to perform intra decoding and inter decoding respectively.

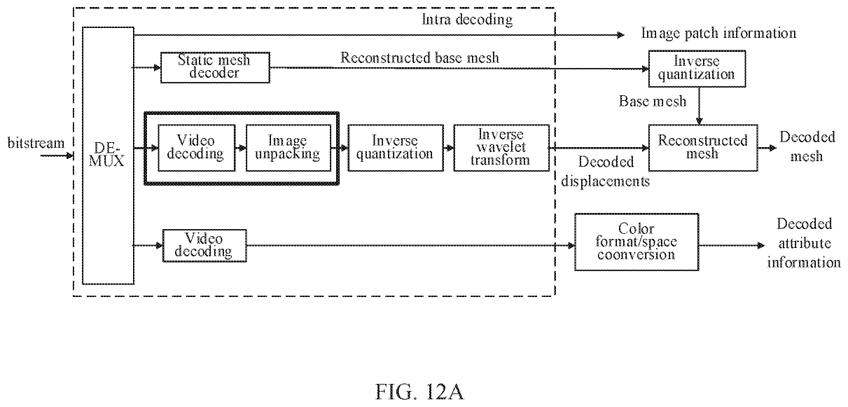

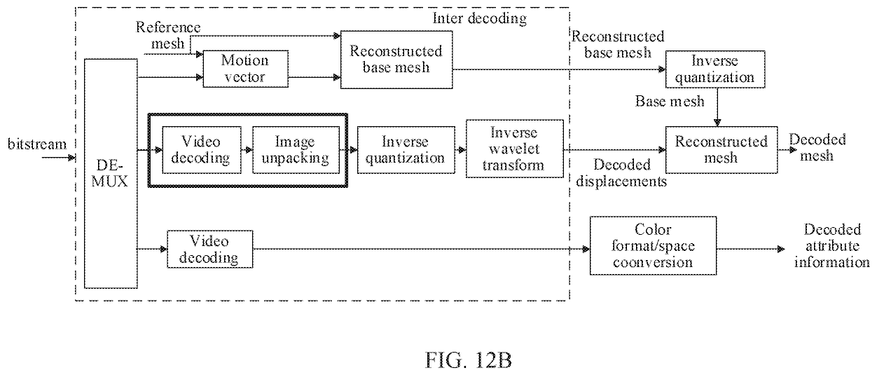

FIG. 12A is a schematic diagram of intra decoding. As illustrated in FIG. 12A, in the intra decoder, a static mesh decoder can be used to decode the base mesh. A video decoder is used to decode the displacement coefficient video, and the displacement coefficients are obtained through video unpacking and inverse wavelet transform. The decoded mesh geometric information is obtained from the decoded base mesh and displacement coefficients. The decoding of the attribute map is directly performed through the video decoder.

FIG. 12B is a schematic diagram of inter decoding. As illustrated in FIG. 12B, the flow of the inter decoder is basically the same as that of the intra decoder. The difference is that the base mesh is not directly decoded; instead, the motion vector is decoded, and the base mesh of the current picture is calculated from the base mesh of the previous picture (e.g., the reference picture).

In summary, currently, in the Dynamic Mesh Coding provided by MPEG, the dynamic mesh encoding process is divided into the following steps. At the encoding end, the quantized base mesh generated by preprocessing is encoded using Google's open-source DRACO encoder; the displacement coefficients after wavelet transform, quantization, and two-dimensional mapping are encoded using HEVC; the two-dimensional attribute map is also directly fed into the HEVC encoder for encoding. At the decoding end, the base mesh bitstream is decoded by DRACO to generate a decoded base mesh; the displacement coefficient bitstream is decoded by HEVC, subjected to inverse two-dimensional mapping, inverse quantization, and inverse transform to generate decoded displacement coefficients; then the decoded base mesh and decoded displacement coefficients are used together to generate a reconstructed three-dimensional mesh geometry; the attribute bitstream is decoded by HEVC to generate a reconstructed attribute map.

### General Test Conditions of MPEG DMC.

a. There are 2 test conditions in total:
Condition 1: all intra, geometry lossy, attribute lossy;
Condition 2: random access, geometry lossy, attribute lossy.
b. General test sequences can include five categories: Cat1-A, Cat1-B, and Cat1-C, all containing geometric information and color attribute information.

In the related art, when performing inter coding on a base mesh, a unified coding mode is usually used to encode the motion vectors for vertices in the base mesh in the three coordinate dimensions (x, y, z), and a unified coding mode flag is used to indicate the coding mode. It can be seen that the inter coding mode of the base mesh in the related art is not yet perfect, thus reducing the coding efficiency of the base mesh. If in each coordinate dimension, the optimal coding mode for that coordinate dimension can be determined for encoding the motion vector for a vertex in the base mesh, and an independent flag can be used to indicate the coding mode corresponding to each coordinate dimension, to enable the decoder to use the corresponding decoding mode for decoding, then the coding efficiency of the base mesh can be greatly improved, thereby improving the coding performance of DMC.

On this basis, the embodiments of the present disclosure provide a coding method. At the encoding end, a base mesh of a current picture is determined. When performing inter coding on the base mesh, a motion vector corresponding to each coordinate dimension for a vertex in the base mesh is determined. Based on the motion vector corresponding to each coordinate dimension for the vertex, encoding cost estimation is performed for at least one coding mode to determine at least one encoding cost for each coordinate dimension. According to the at least one encoding cost, a dimension coding indicator corresponding to each coordinate dimension for the vertex and motion vector encoding information corresponding to the vertex are determined. The dimension coding indicator for each coordinate dimension indicates a motion-vector prediction mode corresponding to that coordinate dimension. In this way, for the motion vector of the base mesh in each coordinate dimension, an optimal coding mode corresponding to the coordinate dimension can be determined by comparing at least one encoding cost, and a dimension coding indicator corresponding to each coordinate dimension is used to indicate to the decoder the decoding mode for that coordinate dimension, thereby improving the coding efficiency and further enhancing the coding performance.

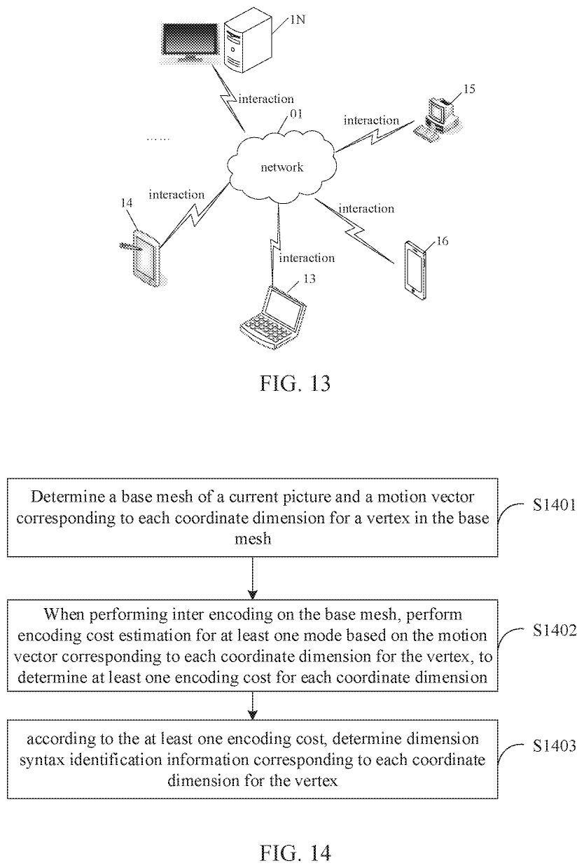

The embodiments of the present disclosure also provide a mesh architecture of a coding system including a decoding method and an encoding method. FIG. 13 is a schematic diagram of a coding mesh architecture according to an embodiment of the present disclosure. As illustrated in FIG. 13, the mesh architecture includes one or more electronic devices 13 to 1N and a communication network 01, where the electronic devices 13 to 1N can perform video interaction through the communication network 01. In implementation, the electronic devices can be various types of devices with encoding and decoding functions. For example, the electronic devices may include a mobile phone, a tablet computer, a personal computer, a personal digital assistant, a navigator, a digital phone, a video phone, a television, a sensor device, a server, etc., which are not specifically limited in the embodiments of the present disclosure. Here, the decoder or encoder described in the embodiments of the present disclosure can be the above-mentioned electronic device.

The embodiments of the present disclosure will be described in detail below with reference to the accompanying drawings.

In another embodiment of the present disclosure, referring to FIG. 14, a first schematic flowchart of an encoding method according to an embodiment of the present disclosure is illustrated. As illustrated in FIG. 14, the method includes the following.

S1401: a base mesh of a current picture and a motion vector corresponding to each coordinate dimension for a vertex in the base mesh are determined.

It should be noted that the encoding method of the embodiment of the present disclosure is applied to an encoder. The encoding method of the embodiment of the present disclosure may refer to an inter encoding method, and more specifically, may be an inter encoding method for a base mesh in a dynamic mesh. The encoding method can be applied to an encoder in V-DMC, but is not limited thereto.

It should also be noted that, in the embodiments of the present disclosure, the base mesh may also be referred to as a “decimated mesh”. In some embodiments, the base mesh of the current picture may be according to an original mesh of the current picture. Specifically, quantization or downsampling processing is performed on the original mesh of the current picture (i.e., the current frame) to determine the base mesh of the current picture.

Exemplarily, downsampling processing may be first performed on the original mesh of the current picture to generate a base mesh with a greatly reduced number of vertices.

In the embodiments of the present disclosure, the base mesh includes multiple vertices. In some embodiments, the vertices in the base mesh may include each vertex in the base mesh. When the encoder uses the inter encoding mode to encode the base mesh, the encoder determines the motion vector of the vertex in the base mesh. The motion vector of the vertex is: a motion vector between a first geometric coordinate of the vertex in the base mesh corresponding to the current picture and a second geometric coordinate of a reference vertex in a reference base mesh corresponding to a reference picture of the current picture.

In the embodiments of the present disclosure, the motion vector of the vertex generally includes motion vectors corresponding to the vertex in multiple coordinate dimensions. Exemplarily, the motion vector of a vertex in a three-dimensional mesh includes motion vectors in the three coordinate dimensions x, y, and z, i.e., a three-dimensional motion vector of the vertex. When the encoder performs inter encoding on the motion vector of a vertex in the base mesh, the encoder first determines the motion vector corresponding to the vertex in each coordinate dimension, so as to use at least one encoding mode for the motion vector corresponding to each coordinate dimension, thereby determining the optimal encoding mode for the vertex in that coordinate dimension.

S1402: When performing inter encoding on the base mesh, encoding cost estimation is performed for at least one mode based on the motion vector corresponding to each coordinate dimension for the vertex, to determine at least one encoding cost for each coordinate dimension.

In the embodiments of the present disclosure, the encoder can perform intra encoding and inter encoding separately on the base mesh, and determine a picture-level encoding mode corresponding to the base mesh of the current picture by comparing the encoding cost of intra encoding and the encoding cost of inter encoding. It should be noted that, in the embodiments of the present disclosure, picture-level is equivalent to frame-level, and picture-level syntax identification information is equivalent to frame-level syntax identification information. When performing inter encoding on the base mesh, the encoder performs encoding cost estimation for at least one mode on the motion vector corresponding to each coordinate dimension for the vertex, to determine the optimal encoding mode and motion vector encoded value corresponding to each coordinate dimension. In some embodiments, the encoded value includes encoding bits.

In the embodiments of the present disclosure, for each coordinate dimension, the encoder performs encoding cost estimation for at least one mode on the motion vector corresponding to that coordinate dimension for the vertex, and determines at least one encoding cost for that coordinate dimension, thereby determining at least one encoding cost for each coordinate dimension. In some embodiments, the at least one mode may include: encoding mode based on at least one prediction mode, that is, each encoding mode in the at least one mode adopts a different prediction mode. Exemplarily, the at least one prediction mode may include at least one of: a non-prediction mode, an intra prediction mode, or an inter prediction mode.

In some embodiments, the at least one encoding cost for each coordinate dimension may include: at least one encoding cost corresponding to each coordinate dimension for a current vertex in the base mesh. That is, for the current vertex in the base mesh, the encoder performs encoding cost estimation for at least one mode on the motion vector corresponding to each coordinate dimension for the current vertex, to determine at least one encoding cost corresponding to each coordinate dimension for the current vertex. The encoder performs encoding cost estimation in the same way for each vertex in the base mesh, thus determining at least one encoding cost corresponding to each coordinate dimension for each vertex.

In some embodiments, the at least one encoding cost for each coordinate dimension may include: at least one encoding cost corresponding to each coordinate dimension for a group of vertices in the base mesh. In the case of group-based encoding on the base mesh, the at least one encoding cost for each coordinate dimension is computed and determined on a group basis, and the dimension syntax identification information corresponding to each coordinate dimension determined according to the at least one encoding cost is determined as the dimension syntax identification information corresponding to the vertices in the current group. That is, in the case of group-based encoding, vertices in the same group correspond to the same dimension syntax identification information in the same coordinate dimension.

In the embodiments of the present disclosure, each vertex corresponds to an index. Exemplarily, if the total number of vertices in the base mesh is N, the indices of vertices in the base mesh can range from 0 to N−1, where N is an integer greater than or equal to 3. In this way, the encoder can encode the vertices in the base mesh according to a preset encoding order, such as from small to large, according to the index corresponding to each vertex. It should be noted that the preset encoding order may also be another order, which is specifically determined according to actual conditions and is not limited in the embodiments of the present disclosure.

In the embodiments of the present disclosure, the encoder can divide the vertices in the base mesh into at least one group according to indices, so as to implement encoding of the base mesh on a group basis. Exemplarily, the group size may be 16, indicating that vertices in the base mesh are grouped in units of 16 vertices, and the number of vertices in the last group is 1 to 16. The group size may also be other values, which are specifically selected according to actual conditions and are not limited in the embodiments of the present disclosure. Taking the total number of vertices in the base mesh as 40 as an example, with a group size of 16, the first group includes vertices with indices 0 to 15, the second group includes vertices with indices 16 to 31, and the third group includes vertices with indices 32 to 39.

In some embodiments, the encoder may encode the base mesh by taking the group-based encoding as a default mode, or may determine whether to perform the group-based encoding on the base mesh according to sequence-level first syntax identification information of a sequence in which the current picture is located and/or second picture-level syntax identification information. The sequence-level first syntax identification information indicates whether to perform group-based encoding on the base meshes of all pictures in the sequence. The second picture-level syntax identification information indicates whether to perform group-based encoding on the base mesh of the current picture.

In some embodiments, the above-mentioned sequence-level first syntax identification information and/or second picture-level syntax identification information indicates whether the encoder performs group-based encoding on the base mesh. Exemplarily, if the value of the sequence-level first syntax identification information and/or the second picture-level syntax identification information is a first identification value, it is determined to perform group-based encoding on the base mesh; if the value of the sequence-level first syntax identification information and/or the second picture-level syntax identification information is a second identification value, it is determined not to perform group-based encoding on the base mesh. In the embodiments of the present disclosure, the first identification value and the second identification value are different. Here, the first identification value and the second identification value can be in the form of parameters, for example, the first identification value can be TRUE or true, and the second identification value can be FALSE or false. The first identification value and the second identification can also be in digital form, for example, the first identification value can be 1 and the second identification value can be 0. Conversely, the first identification value can also be FALSE or false, and the second identification value can be TRUE or true, or the first identification value can be 0 and the second identification value can be 1, etc., which are specifically selected according to actual conditions and are not limited in the embodiments of the present disclosure. In some embodiments, the sequence-level first syntax identification information and/or the second picture-level syntax identification information here may be a parameter written in a profile, or may be a value of a flag, which is not specifically limited here.

In some embodiments, in the case of group-based encoding, such as when group-based encoding is performed by default or it is determined to perform group-based encoding according to the sequence-level first syntax identification information and/or the second picture-level syntax identification information, the encoder may further determine sequence-level second syntax identification information and/or third picture-level syntax identification information. The sequence-level second syntax identification information and/or the third picture-level syntax identification information indicates the number of vertices within a group. That is, the sequence-level second syntax identification information and/or the third picture-level syntax identification information indicates the size of the current group. The encoder can determine the vertices in the current group based on the sequence-level second syntax identification information and/or the third picture-level syntax identification information, so as to encode the vertices in the current group. Exemplarily, the sequence-level second syntax identification information and/or the third picture-level syntax identification information can be 16, or other values, which are specifically selected according to actual conditions and are not limited in the embodiments of the present disclosure.

It should be noted that the encoder performs grouping according to the sequence-level second syntax identification information and/or the third picture-level syntax identification information. When the number of vertices in the base mesh is not an integer multiple of the value of the sequence-level second syntax identification information and/or the third picture-level syntax identification information, the number of vertices in the last group is less than the value of the sequence-level second syntax identification information and/or the third picture-level syntax identification information.

In some embodiments, it is also possible to determine whether to perform group-based encoding on the base mesh according to the sequence-level second syntax identification information and/or the third picture-level syntax identification information. When the sequence-level second syntax identification information and/or the third picture-level syntax identification information is a preset identification value, the encoder encodes the base mesh without grouping. Exemplarily, the preset identification value may be 0 or an identification value in character form. Exemplarily, the preset identification value may be set to a reserved value. The specific implementation is based on actual conditions and is not limited in the embodiments of the present disclosure.

In the embodiments of the present disclosure, the encoding cost can be evaluated and determined by rate and/or distortion cost. In some embodiments, since the encoding of motion vectors of vertices in the base mesh is usually lossless encoding, the rate can be used to estimate the encoding cost for each coordinate dimension. For each coordinate dimension, the encoder can perform rate estimation for at least one mode on the motion vector corresponding to that coordinate dimension for the vertex, so as to determine at least one rate estimation value corresponding to that coordinate dimension. In some embodiments, quality distortion may also be introduced as an encoding cost. For each coordinate dimension, the encoder can perform distortion cost estimation for at least one mode on the motion vector corresponding to that coordinate dimension for the vertex, so as to determine at least one distortion cost corresponding to that coordinate dimension. The encoder can determine the encoding cost corresponding to the vertex in that coordinate dimension based on at least one of the rate estimation value and the distortion cost.

In some embodiments, for each coordinate dimension, the encoder can perform rate estimation for at least one mode according to the motion vector corresponding to the vertex in that coordinate dimension in the base mesh, to determine at least one rate estimation value and/or at least one distortion cost corresponding to the vertex in that coordinate dimension. The encoder can determine at least one encoding cost corresponding to that coordinate dimension for the vertex based on the at least one rate estimation value and/or the at least one distortion cost, thereby determining at least one encoding cost corresponding to that coordinate dimension for each vertex in the base mesh. Since at least one motion vector encoded value corresponds to at least one encoding mode, it can be seen that at least one rate estimation value corresponds to at least one encoding mode, and at least one distortion cost corresponds to at least one encoding mode. When determining the encoding cost by considering both the at least one rate estimation value and the at least one distortion cost, the encoder can combine the rate estimation value and the distortion cost corresponding to the same encoding mode, for example, perform a weighted average, to determine the encoding cost corresponding to that encoding mode, thereby determining at least one encoding cost corresponding to the coordinate dimension for each vertex.

In some embodiments, in the case of group-based encoding, the above-mentioned vertex may refer to a vertex in a current group among at least one group. The encoder performs encoding cost estimation for at least one mode based on the motion vector corresponding to each coordinate dimension for the vertex, to determine at least one encoding cost for each coordinate dimension as follows. For each coordinate dimension, at least one rate estimation value and/or at least one distortion cost corresponding to the coordinate dimension for the current group is determined by performing encoding cost estimation for at least one mode on the motion vector corresponding to the coordinate dimension for each vertex in the current group. At least one encoding cost corresponding to the coordinate dimension for the current group is determined based on the at least one rate estimation value and/or the at least one distortion cost corresponding to the coordinate dimension for the current group, thereby determining at least one encoding cost corresponding to each coordinate dimension for the current group.

In some embodiments, for each coordinate dimension, the encoder determines one rate estimation value corresponding to the coordinate dimension for the current group according to the rate estimation values of the vertices in the current group corresponding to the same mode in that coordinate dimension. In this way, by determining the rate estimation value corresponding to each of the at least one mode, at least one rate estimation value corresponding to the coordinate dimension for the current group is determined. It can be seen that the at least one rate estimation value corresponds to the at least one mode.

In some embodiments, for each coordinate dimension, the encoder determines one distortion cost corresponding to the coordinate dimension for the current group according to the distortion costs of the vertices in the current group corresponding to the same mode in that coordinate dimension. In this way, by determining the distortion cost corresponding to each of the at least one mode, at least one distortion cost corresponding to the coordinate dimension for the current group is determined. It can be seen that the at least one distortion cost corresponds to the at least one mode.

In the embodiments of the present disclosure, the encoder may determine at least one encoding cost corresponding to the coordinate dimension for the current group based on the at least one rate estimation value and/or the at least one distortion cost corresponding to the coordinate dimension for the current group. Exemplarily, the encoder may determine the at least one rate estimation value corresponding to the coordinate dimension for the current group as the at least one encoding cost for each group in that coordinate dimension. Optionally, the encoder may, for each encoding mode, combine the rate estimation value corresponding to that encoding mode and the distortion cost to determine the encoding cost corresponding to that encoding mode. The specific implementation is based on actual conditions and is not limited in the embodiments of the present disclosure.

S1403: according to the at least one encoding cost, dimension syntax identification information corresponding to each coordinate dimension for the vertex is determined.

In the embodiments of the present disclosure, the at least one encoding cost represents the encoding performance of each of the at least one mode in each coordinate dimension. In this way, for each coordinate dimension, the optimal encoding mode for that coordinate dimension can be determined among the at least one mode corresponding to that coordinate dimension, and the dimension syntax identification information for that coordinate dimension is determined according to the preset value of the dimension syntax identification information corresponding to the optimal encoding mode for that coordinate dimension, thereby determining the dimension syntax identification information corresponding to each coordinate dimension for the vertex. It can be seen that the dimension syntax identification information (or referred to as dimension-specific syntax identification information, or dimension-level syntax identification information) corresponding to each coordinate dimension indicates the motion-vector prediction mode corresponding to that coordinate dimension.

It should be noted that, in the embodiments of the present disclosure, the dimension syntax identification information corresponding to different coordinate dimensions for the vertex may be the same or different.

In the embodiments of the present disclosure, at least one preset value may be pre-configured to correspond to at least one encoding mode, and each preset value in the at least one preset value indicates each mode in the at least one mode. In this way, the dimension syntax identification information corresponding to each coordinate dimension for the vertex can be determined according to the preset value corresponding to the optimal encoding mode determined for the vertex in each coordinate dimension.

In some embodiments, for each coordinate dimension, the encoder may determine the dimension syntax identification information corresponding to the coordinate dimension for the vertex according to the smallest encoding cost among the at least one encoding cost, thereby determining the dimension syntax identification information corresponding to each coordinate dimension for the vertex. The encoder performs the same processing for each coordinate dimension, and can determine the dimension syntax identification information corresponding to each coordinate dimension for the vertex.

In some embodiments, for the case of non-group encoding, for example, when the sequence-level first syntax identification information and/or the second picture-level syntax identification information indicates non-group encoding, the vertex in the above process refers to the current vertex, and the at least one encoding cost is the at least one encoding cost corresponding to each coordinate dimension for the current vertex. For each coordinate dimension, the encoder determines at least one encoding cost corresponding to each coordinate dimension for each vertex in the base mesh according to the at least one encoding cost corresponding to each coordinate dimension for the current vertex, and determines the dimension syntax identification information corresponding to each coordinate dimension for each vertex in the base mesh according to the at least one encoding cost corresponding to each coordinate dimension for each vertex, where each vertex includes the current vertex. That is, for the case of non-group encoding, each vertex in the base mesh corresponds to the same dimension syntax identification information in the same coordinate dimension. The dimension syntax identification information corresponding to different coordinate dimensions for each vertex in the base mesh may be the same or different, which is not limited in the embodiments of the present disclosure.

In some embodiments, for the case of group-based encoding, the vertex in the above process refers to a vertex in a current group among at least one group, and the at least one encoding cost is an encoding cost on a group basis. The process in which the encoder determines the dimension syntax identification information corresponding to each coordinate dimension for the vertex according to the at least one encoding cost includes the following. The encoder determines, according to the at least one encoding cost corresponding to each coordinate dimension for the current group, dimension syntax identification information corresponding to each coordinate dimension for the current group, as the dimension syntax identification information corresponding to each coordinate dimension for the vertex in the current group.

That is, for the case of group-based encoding, vertices in the same group correspond to the same dimension syntax identification information in the same coordinate dimension; each vertex in the same group may correspond to the same or different dimension syntax identification information in different coordinate dimensions.

It can be understood that, for the motion vector of the base mesh in each coordinate dimension, the optimal encoding mode corresponding to the coordinate dimension can be determined by comparing at least one encoding cost, and a dimension encoding indicator corresponding to each coordinate dimension can be used to indicate the decoding mode of the decoder for that coordinate dimension, thereby improving the coding efficiency and further enhancing the coding performance.

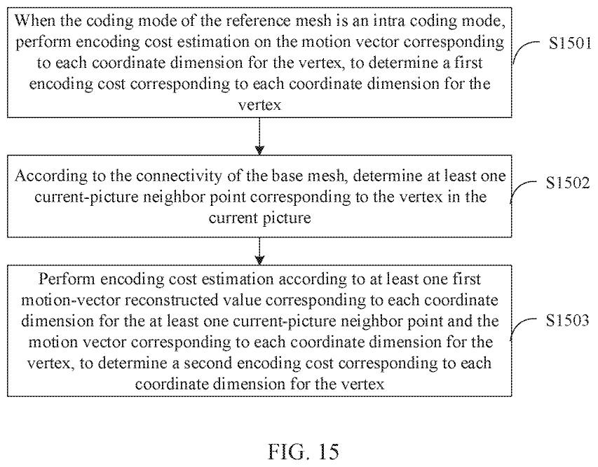

In some embodiments, the at least one mode may include at least one of a non-prediction mode or an intra prediction mode. The at least one encoding cost includes at least one of a first encoding cost or a second encoding cost. The process in S1402 of performing encoding cost estimation for at least one mode based on the motion vector corresponding to each coordinate dimension for the vertex and the encoding mode of the reference mesh, to determine at least one encoding cost corresponding to each coordinate dimension for the vertex, may be implemented by executing the process of S1501, and/or executing the process of S1502-S1503. Taking executing the process of S1501 and the process of S1502-S1503 as an example, FIG. 15 illustrates the process of determining at least one encoding cost corresponding to each coordinate dimension for the vertex in the encoding method according to the embodiments of the present disclosure, specifically as follows.

S1501: When the encoding mode of the reference mesh is an intra encoding mode, encoding cost estimation is performed on the motion vector corresponding to each coordinate dimension for the vertex, to determine a first encoding cost corresponding to each coordinate dimension for the vertex.

In the embodiments of the present disclosure, the process in S1501 corresponds to the non-prediction mode in the at least one encoding mode. In S1501, the encoder directly performs encoding cost estimation on the motion vector corresponding to each coordinate dimension for the vertex in the non-prediction mode, to determine the first encoding cost corresponding to each coordinate dimension for the vertex.

In some embodiments, the motion vector corresponding to the vertex includes: a motion vector mₓ in the x coordinate dimension, a motion vector m_{y} in the y coordinate dimension, and a motion vector m_{z} in the z coordinate dimension corresponding to the vertex. The encoder performs encoding cost estimation on the motion vector mₓ in the non-prediction mode to determine a first encoding cost corresponding to the x coordinate dimension for the vertex; performs encoding cost estimation on the motion vector m_{y} in the non-prediction mode to determine a first encoding cost corresponding to the y coordinate dimension for the vertex; performs encoding cost estimation on the motion vector m_{z} in the non-prediction mode to determine a first encoding cost corresponding to the z coordinate dimension for the vertex, thereby determining the first encoding cost corresponding to each coordinate dimension for the vertex.

S1502: According to the connectivity of the base mesh, at least one current-picture neighbor point corresponding to the vertex in the current picture is determined.

In the embodiments of the present disclosure, the processes of S1502-S1503 correspond to the intra prediction mode. In the intra prediction mode, the motion vector of the current vertex to be encoded may be predicted based on one or more already encoded and reconstructed vertices that have connectivity with the current vertex in the current picture, and an intra prediction residual may be determined based on an intra prediction value and an original value of the motion vector of the vertex, so as to encode the intra prediction residual.

In the embodiments of the present disclosure, the connectivity of the base mesh represents the connection relationship between vertices in the base mesh. The connectivity of the base mesh can be determined by a reference base mesh for the reference picture corresponding to the current picture. Here, the reference base mesh is a base mesh for the reference picture, and the reference mesh includes reference vertices.

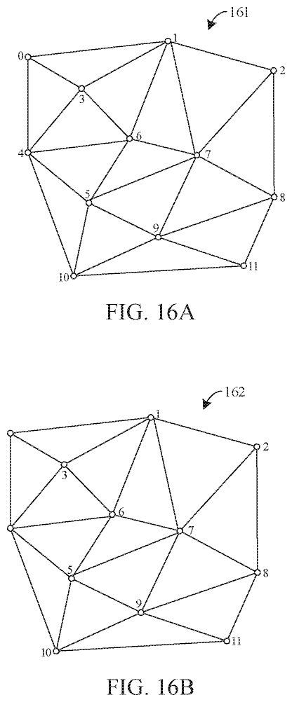

In some embodiments, the connectivity information of the base mesh of the reference picture is the same as the connectivity information of the base mesh of the current picture. Referring to FIG. 16A and FIG. 16B, FIG. 16A illustrates the connectivity of a reference base mesh in a reference picture, and FIG. 16B illustrates the connectivity of a base mesh in a current picture. In FIG. 16A, the numbers next to vertices of triangular faces in the reference base mesh indicate index numbers of the reference vertices, and 161 refers to the reference base mesh of the reference picture. In FIG. 16B, the numbers next to vertices of triangular faces in the base mesh indicate index numbers of the vertices, and 162 refers to the base mesh of the current picture. Vertices in the base mesh 161 and the base mesh 162 with the same index number indicate that these two vertices are actually the same physical point in physical space, but their three-dimensional geometric coordinates (i.e., physical space positions) in the two pictures may be the same or different. It can be seen from FIG. 16A and FIG. 16B that the connectivity of the base mesh 162 of the current picture is the same as the connectivity of the reference base mesh 161 of the reference picture.

In the embodiments of the present disclosure, connectivity includes direct connection or indirect connection. The direct connection means that there is no other vertex on a connection path between the current vertex and a current-picture neighbor vertex, and the indirect connection means that there are one or more other vertices on the connection path between the current vertex and the current-picture neighbor vertex.

In the embodiments of the present disclosure, for the current vertex to be encoded, the encoder determines, according to the connectivity of the base mesh, a vertex in the current picture that has connectivity with the current vertex and whose encoding order is before the vertex, as at least one current-picture neighbor point corresponding to the vertex. It can be seen that the at least one current-picture neighbor point corresponding to the current vertex to be encoded is a vertex in the current picture that has connectivity with the vertex and has been encoded.

In the embodiments of the present disclosure, the number of the at least one current-picture neighbor point is not limited. In some embodiments, the at least one current-picture neighbor point includes an encoded vertex in the base mesh of the current picture that is closest to the current vertex to be encoded and has connectivity with the current vertex. In other embodiments, the at least one current-picture neighbor point includes a first number of encoded vertices in the base mesh of the current picture, each of which is at a distance from the current vertex to be encoded less than a first distance threshold and has connectivity with the current vertex. The first number is an integer greater than 0. The first distance threshold is a preset value, which can be preset according to actual conditions and is not limited in the embodiments of the present disclosure.

Exemplarily, in some embodiments, the at least one current-picture neighbor point includes some or all vertices in the base mesh of the current picture that are directly connected to the current vertex to be encoded and have an encoding order before the vertex.

S1503: encoding cost estimation is performed according to at least one first motion-vector reconstructed value corresponding to each coordinate dimension for the at least one current-picture neighbor point and the motion vector corresponding to each coordinate dimension for the vertex, to determine a second encoding cost corresponding to each coordinate dimension for the vertex.

In the embodiments of the present disclosure, since the at least one current-picture neighbor point corresponding to the vertex is an already encoded vertex, the encoder can reconstruct the current-picture neighbor point, thereby obtaining the motion-vector reconstructed value of the current-picture neighbor point.

In some embodiments, the encoder may determine the motion-vector reconstructed value of the current-picture neighbor point according to a decoded value of the current-picture neighbor point and a prediction mode corresponding to the current-picture neighbor point. It can be understood that the motion-vector reconstructed value of the current-picture neighbor point includes a motion-vector reconstructed value corresponding to each of multiple coordinate dimensions.

Exemplarily, if the prediction mode corresponding to the current-picture neighbor point is a non-prediction mode, the encoder may perform entropy decoding on encoding bits corresponding to the motion vector of the current-picture neighbor point, and then perform inverse quantization on the decoded value of the motion vector of the current-picture neighbor point to determine the motion-vector reconstructed value of the current-picture neighbor point.

Exemplarily, if the prediction mode corresponding to the current-picture neighbor point is an intra prediction mode, the encoder may perform entropy decoding on the encoding bits corresponding to the motion vector of the current-picture neighbor point, then perform inverse quantization on the decoded value of an intra prediction residual, and then add the inverse quantized decoded value of the intra prediction residual to an intra prediction value corresponding to the motion vector of the current-picture neighbor point, so as to determine the motion-vector reconstructed value of the current-picture neighbor point.

Exemplarily, if the prediction mode corresponding to the current-picture neighbor point is an inter prediction mode, the encoder may perform entropy decoding on the encoding bits corresponding to the motion vector of the current-picture neighbor point, then perform inverse quantization on the decoded value of an inter prediction residual, and then add the inverse quantized inter prediction residual to an inter prediction value corresponding to the motion vector of the current-picture neighbor point to determine the motion-vector reconstructed value of the current-picture neighbor point.

In the embodiments of the present disclosure, taking the motion-vector reconstructed value corresponding to each coordinate dimension for each current-picture neighbor point as a first motion-vector reconstructed value, then the at least one current-picture neighbor point corresponds to at least one first motion-vector reconstructed value in each coordinate dimension. The encoder may determine a prediction value of the motion vector corresponding to a coordinate dimension for the vertex, i.e., the first motion-vector prediction value, according to the at least one first motion-vector reconstructed value corresponding to the same coordinate dimension for the at least one current-picture neighbor point. Thus, for each coordinate dimension of the vertex, the encoder performs encoding cost estimation on the residual between the first motion-vector prediction value corresponding to that coordinate dimension and the motion vector corresponding to that coordinate dimension (i.e., the original value of the motion vector corresponding to that coordinate dimension), to determine the intra prediction encoding cost corresponding to that coordinate dimension for the vertex, i.e., the second encoding cost.

In some embodiments, for each coordinate dimension of the vertex, the encoder may perform a weighted average on the at least one first motion-vector reconstructed value corresponding to each coordinate dimension to determine the first motion-vector prediction value corresponding to each coordinate dimension for the vertex; determine a first residual corresponding to each coordinate dimension for the vertex according to the motion vector and the first motion-vector prediction value corresponding to each coordinate dimension for the vertex; perform encoding cost estimation on the first residual corresponding to each coordinate dimension for the vertex to determine the encoding cost corresponding to each coordinate dimension for the vertex.

That is, for each coordinate dimension, the encoder determines the first residual corresponding to the vertex in that coordinate dimension according to the motion vector corresponding to the vertex in that coordinate dimension and the first motion-vector prediction value corresponding to the vertex in that coordinate dimension. The encoder performs encoding cost estimation on the first residual corresponding to the vertex in that coordinate dimension to determine the second encoding cost corresponding to the vertex in that coordinate dimension. Here, the first residual represents the intra prediction residual.

In the above process, the at least one first motion-vector reconstructed value corresponds to the at least one current-picture neighbor point. The embodiments of the present disclosure do not limit the weights of the at least one current-picture neighbor point participating in the weighted average. All current-picture neighbor points may have the same weight or different weights. The weight of each current-picture neighbor point may be a preset value, or may be determined according to its distance from the current vertex to be encoded. For example, the weight of the current-picture neighbor point is a value negatively correlated with its distance from the current vertex to be encoded.

Exemplarily, the first motion-vector prediction value corresponding to the x coordinate dimension for the vertex is P_{cx}, the first motion-vector prediction value corresponding to the y coordinate dimension for the vertex is P_{cy}, and the first motion-vector prediction value corresponding to the z coordinate dimension for the vertex is P_{cz}. The encoder performs encoding cost estimation on the first residual corresponding to the x coordinate dimension for the vertex, mₓ−P_{cx}, to determine the second encoding cost corresponding to the x coordinate dimension; the encoder performs encoding cost estimation on the first residual corresponding to the y coordinate dimension for the vertex, m_{y}−P_{cy} to determine the second encoding cost corresponding to the y coordinate dimension; the encoder performs encoding cost estimation on the first residual corresponding to the z coordinate dimension for the vertex, m_{z}−P_{cz}, to determine the second encoding cost corresponding to the z coordinate dimension; thereby determining the second encoding cost corresponding to each coordinate dimension for the vertex.

It should be noted that, in practical applications, at least one encoding cost corresponding to each coordinate dimension for each vertex may also be determined by executing the process of S1501, or by executing the process of S1502-S1503. The specific implementation is based on actual conditions and is not limited in the embodiments of the present disclosure.

It can be understood that, by encoding the motion vector corresponding to each coordinate dimension for the vertex based on the non-prediction mode and/or the intra prediction mode, the encoding performance of the motion vector in each coordinate dimension under different prediction modes can be determined, and then the motion vector of the vertex can be encoded according to the prediction mode with the optimal encoding performance, thereby improving the encoding accuracy and efficiency of the base mesh, and further enhancing the encoding performance.

In some embodiments, the encoder may perform encoding cost estimation for at least one mode based on the motion vector corresponding to each coordinate dimension for the vertex and the encoding mode of the reference mesh, to determine at least one encoding cost corresponding to each coordinate dimension for the vertex, where the reference mesh is a base mesh of a reference picture corresponding to the current picture.

In some embodiments, when the encoding mode of the reference mesh is intra encoding, the encoder may perform encoding cost estimation for at least one of a non-prediction mode and an intra prediction mode on the motion vector corresponding to each coordinate dimension for the vertex, to determine at least one encoding cost corresponding to each coordinate dimension for the vertex. The at least one encoding cost includes at least one of: a first encoding cost corresponding to the non-prediction mode, and a second encoding cost corresponding to the intra prediction mode.

That is, when the encoding mode of the reference mesh is intra encoding, the encoder performs encoding cost estimation on the motion vector corresponding to each coordinate dimension for the vertex to determine the first encoding cost corresponding to each coordinate dimension for the vertex. Alternatively or additionally, the encoder performs encoding cost estimation according to at least one first motion-vector reconstructed value corresponding to each coordinate dimension for the at least one current-picture neighbor point corresponding to the vertex and the motion vector corresponding to each coordinate dimension for the vertex, to determine the second encoding cost corresponding to each coordinate dimension for the vertex. The above process is consistent with the description of the processes S1501-S1503, and will not be repeated here.

In some embodiments, the at least one encoding mode may include at least one of: an encoding mode based on a non-prediction mode, an encoding mode based on an intra prediction mode, or an encoding mode based on an inter prediction mode. When the encoding mode of the reference base mesh is inter encoding, the encoder may perform encoding cost estimation for at least one of the non-prediction mode, the intra prediction mode, and the inter prediction mode on the motion vector corresponding to each coordinate dimension for the vertex, to determine at least one encoding cost corresponding to each coordinate dimension for the vertex. The at least one encoding cost includes at least one of: a first encoding cost corresponding to the non-prediction mode, a second encoding cost corresponding to the intra prediction mode, and a third encoding cost corresponding to the inter prediction mode.

That is, when the encoding mode of the reference base mesh is inter encoding, the encoder performs encoding cost estimation on the motion vector corresponding to each coordinate dimension for the vertex to determine the first encoding cost corresponding to each coordinate dimension for the vertex. Alternatively or additionally, the encoder performs encoding cost estimation according to at least one first motion-vector reconstructed value corresponding to each coordinate dimension for the at least one current-picture neighbor point corresponding to the vertex and the motion vector corresponding to each coordinate dimension for the vertex, to determine the second encoding cost corresponding to each coordinate dimension for the vertex. Alternatively or additionally, the encoder determines at least one reference-picture neighbor point corresponding to the vertex in the reference picture, where the at least one reference-picture neighbor point includes a reference vertex determined based on a co-located point corresponding to the vertex in the reference picture; performs encoding cost estimation according to at least one second motion-vector reconstructed value corresponding to each coordinate dimension for the at least one reference-picture neighbor point and the motion vector corresponding to each coordinate dimension for the vertex, to determine the third encoding cost corresponding to each coordinate dimension for the vertex.

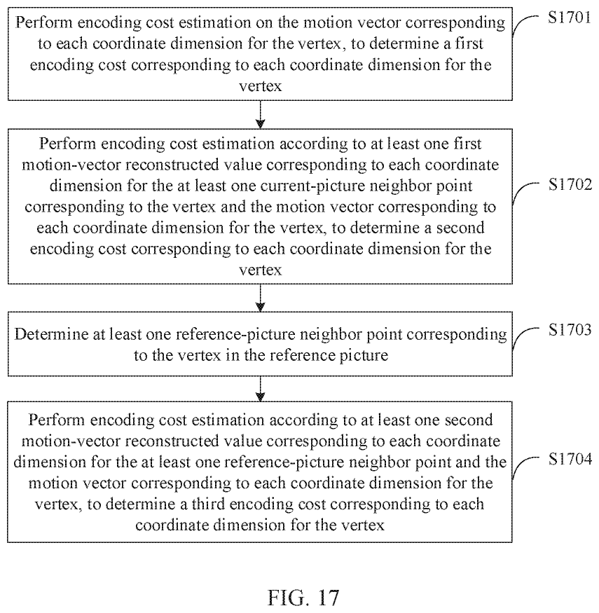

In some embodiments, when the encoding mode corresponding to the reference picture is inter encoding, taking the encoder performing encoding cost estimation for three modes, namely the non-prediction mode, the intra prediction mode, and the inter prediction mode, on the motion vector corresponding to each coordinate dimension for the vertex as an example, FIG. 17 illustrates the process of determining at least one encoding cost corresponding to each coordinate dimension for the vertex in the encoding method according to the embodiment of the present disclosure, specifically as follows.

S1701: encoding cost estimation is performed on the motion vector corresponding to each coordinate dimension for the vertex, to determine a first encoding cost corresponding to each coordinate dimension for the vertex.

S1702: encoding cost estimation is performed according to at least one first motion-vector reconstructed value corresponding to each coordinate dimension for the at least one current-picture neighbor point corresponding to the vertex and the motion vector corresponding to each coordinate dimension for the vertex, to determine a second encoding cost corresponding to each coordinate dimension for the vertex.

The processes of determining the first encoding cost and the second encoding cost corresponding to each coordinate dimension for each vertex in S1701 and S1702 are consistent with the description of the processes S1501 and S1503 above, and will not be repeated here.

S1703: at least one reference-picture neighbor point corresponding to the vertex is determined in the reference picture.

In the embodiments of the present disclosure, the at least one reference-picture neighbor point is a reference vertex determined based on a co-located point corresponding to the vertex in the reference picture. The processes of S1703-S1704 correspond to the inter prediction mode. In the inter prediction mode, the motion vector of the vertex is determined based on one or more already encoded and reconstructed reference vertices in the reference picture corresponding to the current vertex to be encoded, and an inter prediction residual is determined based on the inter prediction value and the original value of the motion vector of the vertex, so as to encode the inter prediction residual.

In some embodiments, the process of the encoder determining at least one reference-picture neighbor point corresponding to each vertex may include the following.

In the reference picture, a reference vertex having the same index as the current vertex to be encoded is determined as the co-located point corresponding to the vertex. At least one of the co-located point or a reference vertex having connectivity with the co-located point in the reference picture is determined as the at least one reference-picture neighbor point corresponding to the vertex.

In some embodiments, when the encoder has determined at least one current-picture neighbor point corresponding to the base mesh, a reference vertex that has the same index as the at least one current-picture neighbor point may also be determined in the reference picture, as the at least one reference-picture neighbor point.

In the embodiments of the present disclosure, connectivity includes direct connection or indirect connection. The direct connection means that there is no other vertex on the connection path between the current vertex and the current-picture neighbor vertex, and the indirect connection means that there are one or more other vertices on the connection path between the current vertex and the current-picture neighbor vertex.

Exemplarily, the at least one reference-picture neighbor point may include at least one of the following: the co-located point, all reference vertices having connectivity with the co-located point in the reference picture, the co-located point and all reference vertices having connectivity with the co-located point in the reference picture, or some reference vertices from a set of reference vertices consisting of the co-located point and all reference vertices having connectivity with the co-located point in the reference picture.

It can be understood that the at least one reference-picture neighbor point corresponding to the current vertex to be encoded is an already encoded vertex. In the embodiments of the present disclosure, the number of the at least one reference-picture neighbor point is not limited. In some embodiments, the at least one reference-picture neighbor point includes an encoded reference vertex in the reference base mesh that is closest to the co-located point of the current vertex to be encoded and has connectivity with the co-located point. In other embodiments, the at least one reference-picture neighbor point includes a second number of encoded vertices in the reference base mesh, each of which is at a distance from the current vertex to be encoded less than a second distance threshold and has connectivity with the co-located point. The second number is an integer greater than 0. The second distance threshold is a preset value. The first number and the second number may be the same or different, and the first distance threshold and the second distance threshold may be the same or different, which are specifically implemented according to actual conditions and are not limited in the embodiments of the present disclosure.

Exemplarily, the at least one reference-picture neighbor point includes some or all vertices, in the reference base mesh of the reference picture, that are directly connected to the co-located point of the current vertex to be encoded and have an encoding order before the co-located point.

Exemplarily, since the indices of vertices in the base mesh are the same as that of the co-located points in the reference base mesh, after determining the at least one current-picture neighbor point, the encoder may also determine a reference vertex in the reference base mesh having the same index as the at least one current-picture neighbor point as the at least one reference-picture neighbor point.

S1704: encoding cost estimation is performed according to at least one second motion-vector reconstructed value corresponding to each coordinate dimension for the at least one reference-picture neighbor point and the motion vector corresponding to each coordinate dimension for the vertex, to determine a third encoding cost corresponding to each coordinate dimension for the vertex.

In the embodiments of the present disclosure, since the at least one reference-picture neighbor point corresponding to the vertex is an already encoded vertex, the encoder may reconstruct the reference-picture neighbor point, thereby obtaining the motion-vector reconstructed value of the reference-picture neighbor point.

In some embodiments, the encoder may determine the motion-vector reconstructed value of the reference-picture neighbor point according to a decoded value of the reference-picture neighbor point and a prediction mode corresponding to the reference-picture neighbor point. It can be understood that the motion-vector reconstructed value of the reference-picture neighbor point includes a motion-vector reconstructed value corresponding to each of multiple coordinate dimensions.

Exemplarily, if the prediction mode corresponding to the reference-picture neighbor point is a non-prediction mode, the encoder may perform entropy decoding on the encoding bits corresponding to the motion vector of the reference-picture neighbor point, and then perform inverse quantization on the decoded value of the motion vector of the reference-picture neighbor point to determine the motion-vector reconstructed value of the reference-picture neighbor point.

Exemplarily, if the prediction mode corresponding to the reference-picture neighbor point is an intra prediction mode, the encoder may perform entropy decoding on the encoding bits corresponding to the motion vector of the reference-picture neighbor point, then perform inverse quantization on the decoded value of the intra prediction residual, and then add the inverse quantized decoded value of the intra prediction residual to the intra prediction value corresponding to the motion vector of the reference-picture neighbor point, so as to determine the motion-vector reconstructed value of the reference-picture neighbor point.

Exemplarily, if the prediction mode corresponding to the reference-picture neighbor point is an inter prediction mode, the encoder may perform entropy decoding on the encoding bits corresponding to the motion vector of the reference-picture neighbor point, then perform inverse quantization on the decoded value of the inter prediction residual, and then add the inverse quantized inter prediction residual to the inter prediction value corresponding to the motion vector of the reference-picture neighbor point to determine the motion-vector reconstructed value of the reference-picture neighbor point.

In the embodiments of the present disclosure, taking the motion-vector reconstructed value corresponding to each coordinate dimension for the reference current-picture neighbor point as a second motion-vector reconstructed value, then the at least one reference-picture neighbor point corresponds to at least one second motion-vector reconstructed value in each coordinate dimension. The encoder may determine the prediction value of the motion vector corresponding to the vertex in a coordinate dimension, i.e., the second motion-vector prediction value, according to the at least one second motion-vector reconstructed value corresponding to the same coordinate dimension for the at least one reference-picture neighbor point. Thus, for each coordinate dimension of the vertex, the encoder performs encoding cost estimation on the residual between the second motion-vector prediction value corresponding to the coordinate dimension and the motion vector corresponding to the coordinate dimension (i.e., the original value of the motion vector corresponding to the coordinate dimension), to determine the inter prediction encoding cost corresponding to the coordinate dimension for the vertex, as the third encoding cost corresponding to the coordinate dimension for the vertex. Thus, through the above process, the vertex is processed in each coordinate dimension to determine the third encoding cost corresponding to each coordinate dimension for the vertex.

In some embodiments, for each coordinate dimension of the vertex, the encoder may perform a weighted average on the at least one second motion-vector reconstructed value to determine the second motion-vector prediction value corresponding to the coordinate dimension for the vertex; determine a second residual corresponding to the coordinate dimension for the vertex according to the motion vector corresponding to the coordinate dimension for the vertex and the second motion-vector prediction value; perform encoding cost estimation on the second residual corresponding to the coordinate dimension for the vertex to determine the third encoding cost corresponding to the coordinate dimension for the vertex.

That is, for each coordinate dimension, the encoder determines the second residual corresponding to the vertex in the coordinate dimension according to the motion vector corresponding to the vertex in the coordinate dimension and the second motion-vector prediction value corresponding to the vertex in the coordinate dimension. The encoder performs encoding cost estimation on the second residual corresponding to the vertex in the coordinate dimension to determine the third encoding cost corresponding to the vertex in the coordinate dimension. Here, the second residual represents the inter prediction residual.

In the above process, the at least one second motion-vector reconstructed value corresponds to the at least one reference-picture neighbor point. The embodiments of the present disclosure do not limit the weights of the at least one reference-picture neighbor point participating in the weighted average. All reference-picture neighbor points may have the same weight or different weights. The weight of each reference-picture neighbor point may be a preset value, or may be determined according to its distance from the co-located point of the current vertex to be encoded. For example, the weight of a reference-picture neighbor point is a value negatively correlated with its distance from the co-located point of the current vertex to be encoded.

Exemplarily, the second motion-vector prediction value corresponding to the x coordinate dimension for the vertex is Pᵣₓ, the second motion-vector prediction value corresponding to the y coordinate dimension for the vertex is P_{ry}, and the second motion-vector prediction value corresponding to the z coordinate dimension for the vertex is P_{rz}. The encoder performs encoding cost estimation on the second residual corresponding to the x coordinate dimension for the vertex, mₓ−Pᵣₓ, to determine the third encoding cost corresponding to the x coordinate dimension. The encoder performs encoding cost estimation on the second residual corresponding to the vertex in the y coordinate dimension, m_{y}−P_{ry}, to determine the third encoding cost corresponding to the y coordinate dimension. The encoder performs encoding cost estimation on the second residual corresponding to the z coordinate dimension for the vertex, m_{z}−P_{rz}, to determine the third encoding cost corresponding to the z coordinate dimension. In this way, the third encoding cost corresponding to each coordinate dimension for the vertex is determined.

It should be noted that, in practical applications, at least one encoding cost corresponding to each coordinate dimension for the vertex may also be determined by executing one or more of the processes S1701, S1702, and S1703-S1704. The specific implementation is based on actual conditions and is not limited in the embodiments of the present disclosure.

It can be understood that, by combining the encoding mode of the reference base mesh of the reference picture, the motion vector corresponding to each coordinate dimension for the vertex is encoded based on at least one of the non-prediction mode, the intra prediction mode, or the inter prediction mode, and the encoding performance of the motion vector in each coordinate dimension under different prediction modes can be determined. In this way, the motion-vector encoded value of the vertex can be determined according to the prediction mode with the optimal encoding performance, thereby improving the encoding accuracy and efficiency of the base mesh, and further enhancing the encoding performance.

In some embodiments of the present disclosure, based on the process in FIG. 15 above, the process of determining the dimension syntax identification information corresponding to each coordinate dimension for the vertex and the motion vector encoding information corresponding to the vertex according to the at least one encoding cost may include the following.

For each coordinate dimension, when the first encoding cost is less than or equal to the second encoding cost, the dimension syntax identification information corresponding to the coordinate dimension for the vertex is determined as a first value, where the first value indicates that the motion-vector prediction mode corresponding to the coordinate dimension is the non-prediction mode.

When the first encoding cost is greater than the second encoding cost, the dimension syntax identification information corresponding to the coordinate dimension for the vertex is determined as a second value, where the second value indicates that the motion-vector prediction mode corresponding to the coordinate dimension is the intra prediction mode.

Exemplarily, for the case of non-group encoding, when the first encoding cost is less than or equal to the second encoding cost, the encoder determines the dimension syntax identification information corresponding to the coordinate dimension for the current vertex to be encoded as the first value. For the case of group-based encoding, when the first encoding cost is less than or equal to the second encoding cost, the encoder determines the dimension syntax identification information corresponding to the coordinate dimension for the current group to be encoded as the first value, that is, the motion-vector prediction mode for each vertex in the current group in that coordinate dimension is the non-prediction mode indicated by the first value.

Exemplarily, the encoding cost may be a rate estimation value. When the rate estimation value bits0 corresponding to the non-prediction mode is less than or equal to the rate estimation value bits1 corresponding to the intra prediction mode, the dimension syntax identification information is determined as the first value. When the rate estimation value bits0 corresponding to the non-prediction mode is greater than the rate estimation value bits1 corresponding to the intra prediction mode, the dimension syntax identification information is determined as the second value. By performing the above processing for each coordinate dimension corresponding to the vertex, the dimension syntax identification information corresponding to each coordinate dimension for the vertex can be determined.

In some embodiments of the present disclosure, based on the process in FIG. 17 above, the process of determining the dimension syntax identification information corresponding to each coordinate dimension for the vertex according to the at least one encoding cost may include the following.

For each coordinate dimension, when the third encoding cost is less than or equal to the second encoding cost and the third encoding cost is less than or equal to the first encoding cost, the dimension syntax identification information corresponding to the coordinate dimension for the vertex is determined as a third value, where the third value indicates that the motion-vector prediction mode corresponding to the coordinate dimension is the inter prediction mode.

When the third encoding cost is less than or equal to the second encoding cost and the third encoding cost is greater than the first encoding cost, the dimension syntax identification information corresponding to the coordinate dimension for the vertex is determined as the first value.

When the third encoding cost is greater than the second encoding cost and the second encoding cost is less than or equal to the first encoding cost, the dimension syntax identification information corresponding to the coordinate dimension for the vertex is determined as the second value.

When the third encoding cost is greater than the second encoding cost and the second encoding cost is greater than the first encoding cost, the dimension syntax identification information corresponding to the coordinate dimension for the vertex is determined as the first value.

Exemplarily, for the case of non-group encoding, when the third encoding cost is less than or equal to the second encoding cost and the third encoding cost is less than or equal to the first encoding cost, the encoder determines the dimension syntax identification information corresponding to the coordinate dimension for the current vertex as the third value. For the case of group-based encoding, when the third encoding cost is less than or equal to the second encoding cost and the third encoding cost is less than or equal to the first encoding cost, the encoder determines the dimension syntax identification information corresponding to the coordinate dimension for the current group as the third value, that is, the motion-vector prediction mode for each vertex in the current group in that coordinate dimension is the inter prediction mode indicated by the third value.

Exemplarily, the encoding cost may be a rate estimation value. When the rate estimation value bits2 corresponding to the inter prediction mode is less than or equal to the rate estimation value bits1 corresponding to the intra prediction mode, and the rate estimation value bits2 corresponding to the inter prediction mode is less than or equal to the rate estimation value bits0 corresponding to the non-prediction mode, the dimension syntax identification information is determined as the third value.

Exemplarily, when the rate estimation value bits2 corresponding to the inter prediction mode is less than or equal to the rate estimation value bits1 corresponding to the intra prediction mode, and the rate estimation value bits2 corresponding to the inter prediction mode is greater than the rate estimation value bits0 corresponding to the non-prediction mode, the dimension syntax identification information is determined as the first value.

Exemplarily, when the rate estimation value bits2 corresponding to the inter prediction mode is greater than the rate estimation value bits1 corresponding to the intra prediction mode, and the rate estimation value bits1 corresponding to the intra prediction mode is less than or equal to the rate estimation value bits0 corresponding to the non-prediction mode, the dimension syntax identification information is determined as the second value.

Exemplarily, when the rate estimation value bits2 corresponding to the inter prediction mode is greater than the rate estimation value bits/corresponding to the intra prediction mode, and the rate estimation value bits1 corresponding to the intra prediction mode is greater than the rate estimation value bits0 corresponding to the non-prediction mode, the dimension syntax identification information is determined as the first value.

The above embodiment is an example of determining the dimension syntax identification information corresponding to each coordinate dimension based on at least one encoding cost. In practical applications, based on the comparison of the at least one encoding cost, the dimension syntax identification information corresponding to each coordinate dimension may be determined in different ways. For example, when the first encoding cost is equal to the second encoding cost, the dimension syntax identification information may be determined as the second value; or when the third encoding cost is equal to the first encoding cost, the dimension syntax identification information may be determined as the third value, etc. The specific implementation is based on actual conditions and is not limited in the embodiments of the present disclosure.

It should be noted that, in the embodiments of the present disclosure, the above-mentioned first value, second value, and third value are different, so as to distinguish different motion-vector prediction modes. In some embodiments, the first value, the second value, and the third value may be in the form of parameters, such as using different preset character strings to represent the non-prediction mode, the intra prediction mode, and the inter prediction mode respectively. The first value, the second value, and the third value may also be in digital form, such as the first value may be 0, the second value may be 1, and the third value may be 2; or, the first value may be 00, the second value may be 01, and the third value may be 10, etc., which are specifically selected according to actual conditions and are not limited in the embodiments of the present disclosure. In some embodiments, the first value, the second value, and the third value here may be parameters written in a profile, or may be values of a flag, which is not specifically limited here.

It should also be noted that the above embodiment is illustrated by taking the at least one encoding mode including three encoding modes as an example. In practical applications, the at least one encoding mode may also include more encoding modes, and the dimension syntax identification information may have a reserved value preset for extensions. For example, the first value may be 0, the second value may be 1, the third value may be 2, and 3 may be reserved as a reserved value, etc. The specific implementation is based on actual conditions and is not limited in the embodiments of the present disclosure.

In some embodiments, after determining the dimension syntax identification information corresponding to each coordinate dimension for the vertex through the above encoding method, the encoder may further encode the motion vector corresponding to each coordinate dimension for the vertex according to the dimension syntax identification information corresponding to each coordinate dimension for the vertex, to determine motion vector encoding information corresponding to the vertex, and determine first picture-level syntax identification information corresponding to the base mesh based on the motion vector encoding information corresponding to the vertex. The first picture-level syntax identification information represents the encoding mode corresponding to the base mesh and is used to indicate the decoding mode corresponding to the base mesh.

Here, since the motion vector encoding information corresponding to the vertex is obtained by inter encoding on the base mesh, the encoder may determine inter encoding information corresponding to the entire base mesh based on the motion vector encoding information corresponding to each vertex in the base mesh, and then determine an inter encoding cost corresponding to the base mesh. In some embodiments, the encoder determines the first picture-level syntax identification information corresponding to the base mesh, i.e., determines whether the encoding mode for the base mesh is inter encoding or intra encoding, by comparing the inter encoding cost of the base mesh with the intra encoding cost.

In some embodiments, if the value of the first picture-level syntax identification information is a third identification value, inter encoding is determined as the encoding mode corresponding to the base mesh. If the value of the first picture-level syntax identification information is a fourth identification value, intra encoding is determined as the encoding mode corresponding to the base mesh. In the embodiments of the present disclosure, the third identification value and the fourth identification value are different. For example, the third identification value and the fourth identification value may be in the form of parameters, such as the third identification value may be FALSE or false, and the fourth identification value may be TRUE or true. The third identification value and the fourth identification value may also be in digital form, such as the third identification value may be 0 and the fourth identification value may be 1. Conversely, the third identification value may also be TRUE or true, and the fourth identification value may be FALSE or false, or the third identification value may be 1 and the fourth identification value may be 0, etc., which are specifically selected according to actual conditions and are not limited in the embodiments of the present disclosure. In some embodiments, the first picture-level syntax identification information here may be a parameter written in a profile, or may be a value of a flag, which is not specifically limited here.

In some embodiments, when the first picture-level syntax identification information indicates inter encoding, the encoder may further determine whether to indicate the dimension syntax identification information on a vertex basis or on a group basis according to whether group-based encoding has been performed.

In some embodiments, when the first picture-level syntax identification information indicates inter encoding, a bitstream is generated based on the first picture-level syntax identification information and the dimension syntax identification information corresponding to each coordinate dimension for the vertex.

In another example, a bitstream is generated based on the first picture-level syntax identification information and the dimension syntax identification information corresponding to each coordinate dimension for each of at least one group in the base mesh. The dimension syntax identification information corresponding to each coordinate dimension for each group indicates the dimension syntax identification information corresponding to each coordinate dimension for vertices in the group.

Exemplarily, when the first picture-level syntax identification information indicates inter encoding, if the sequence-level first syntax identification information and/or the second picture-level syntax identification information indicates non-group encoding, or if the sequence-level second syntax identification information and/or the third picture-level syntax identification information is a preset identification value, the encoder generates a bitstream based on the dimension syntax identification information corresponding to each coordinate dimension for the vertex and the motion-vector encoding information corresponding to the vertex. That is, the dimension syntax identification information corresponding to each coordinate dimension for the vertex and the motion vector encoding information corresponding to the vertex are signalled into the bitstream and sent to the decoder.

In some embodiments, when the sequence-level first syntax identification information and/or the second picture-level syntax identification information indicates group-based encoding, or group-based encoding is performed by default, the encoder may perform inter encoding on each of the at least one group of the base mesh according to a preset encoding order, to determine a dimension encoding indicator corresponding to each coordinate dimension for each group and motion vector encoding information corresponding to each group. The process of performing inter encoding on each of the at least one group of the base mesh includes performing inter encoding on each vertex in each group. Here, inter encoding on vertices in a group may also be performed according to the indices of the vertices in the group and the preset encoding order. That is, the motion-vector encoding information corresponding to each group is determined by the motion-vector encoding information corresponding to the vertices in each group.

It can be understood that in the embodiments of the present disclosure, a prediction encoding mode for the motion vector is determined at the coordinate dimension level by comparing at least one encoding cost, and the dimension syntax identification information corresponding to the prediction encoding mode is signalled into the bitstream and sent to the decoder, so as to instruct the decoder to decode according to the dimension syntax identification information corresponding to each coordinate dimension. Thus, from the at least one encoding mode corresponding to the at least one encoding cost, the optimal encoding mode for each coordinate dimension can be selected for encoding and decoding, improving the encoding efficiency and performance.

In an embodiment of the present disclosure, FIG. 18 is a schematic flowchart of a decoding method according to an embodiment of the present disclosure. As illustrated in FIG. 18, the method may include the following.

S1801: a bitstream is parsed to determine first picture-level syntax identification information corresponding to a base mesh of a current picture.

It should be noted that the decoding method of the embodiment of the present disclosure is applied to a decoder, and the decoding method of the embodiment of the present disclosure may refer to an inter decoding method, and more specifically, may be an inter decoding method for a base mesh in a dynamic mesh. The decoding method can be applied to a decoder in V-DMC, but is not limited thereto.

In the embodiments of the present disclosure, the decoder determines the first picture-level syntax identification information by parsing the bitstream. The first picture-level syntax identification information is used to indicate to the decoder the decoding mode for the base mesh of the current picture. Exemplarily, the first picture-level syntax identification information indicates whether the decoding mode for the base mesh is inter decoding or intra decoding.

In some embodiments, when the first picture-level syntax identification information parsed from the bitstream is a third identification value, the decoder determines that the first picture-level syntax identification information indicates inter decoding. Exemplarily, the first picture-level syntax identification information may include the third identification value and a fourth identification value, where the third identification value indicates that the decoding mode corresponding to the base mesh is inter decoding, and the fourth identification value indicates that the decoding mode corresponding to the base mesh is intra decoding. The third identification value and the fourth identification value are different. For example, the third identification value and the fourth identification value can be in the form of parameters, such as the third identification value can be FALSE or false, and the fourth identification value can be TRUE or true. The third identification value and the fourth identification value can also be in digital form, such as the third identification value can be 0 and the fourth identification value can be 1. Conversely, the third identification value can be TRUE or true, and the fourth identification value can be FALSE or false, or the third identification value can be 1 and the fourth identification value can be 0, etc., which are specifically selected according to actual conditions and are not limited in the embodiments of the present disclosure.

In some embodiments, the decoder may perform decoding in a group-based decoding mode or a non-group decoding mode. For the group-based decoding mode, the vertex in the base mesh includes a vertex in a current group among at least one group of the base mesh. For the non-group decoding mode, the vertex in the base mesh includes a current vertex in the base mesh.

In some embodiments, the decoder may determine whether to perform group-based decoding through sequence-level first syntax identification information and/or second picture-level syntax identification information. The sequence-level first syntax identification information indicates whether group-based encoding is performed on the base meshes of all pictures in the sequence, and the second picture-level syntax identification information indicates whether group-based encoding is performed on the base mesh of the current picture.

Exemplarily, through the above bitstream parsing process, the decoder may parse out the sequence-level first syntax identification information and/or the second picture-level syntax identification information from the bitstream, and determine whether to perform decoding on a group basis or on a vertex basis according to the sequence-level first syntax identification information and/or the second picture-level syntax identification information corresponding to the base mesh. That is, the sequence-level first syntax identification information and/or the second picture-level syntax identification information corresponding to the base mesh indicates to the decoder whether to perform group-based decoding on the base mesh. Exemplarily, if the value of the sequence-level first syntax identification information and/or the second picture-level syntax identification information is a first identification value, it is determined to perform group-based decoding on the base mesh; if the value of the sequence-level first syntax identification information and/or the second picture-level syntax identification information is a second identification value, it is determined not to perform group-based decoding on the base mesh. In the embodiments of the present disclosure, the first identification value and the second identification value are different. Here, the first identification value and the second identification value can be in the form of parameters, such as the first identification value can be TRUE or true, and the second identification value can be FALSE or false. The first identification value and the second identification value can also be in digital form, such as the first identification value can be 1 and the second identification value can be 0. Conversely, the first identification value can also be FALSE or false, and the second identification value can be TRUE or true, or the first identification value can be 0 and the second identification value can be 1, etc., which are specifically selected according to actual conditions and are not limited in the embodiments of the present disclosure. In some embodiments, the sequence-level first syntax identification information and/or the second picture-level syntax identification information here may be a parameter written in a profile, or may be a value of a flag, which is not specifically limited here.

Exemplarily, the sequence-level first syntax identification information may be represented by bmsps_inter_mesh_motion_group, the first value may be set to 1, and the second value may be set to 0. If bmsps_inter_mesh_motion_group is 0, it indicates that group-based encoding is not performed on the base mesh. If bmsps_inter_mesh_motion_group is 1, it indicates that group-based encoding is performed on the base mesh. The syntax element structure representation may be as illustrated in Table 1, as follows:

```
TABLE 1
  if (bmsps_inter_mesh_motion_group){
    groupSize = bmsps_inter_mesh_motion_group_size_minus1 + 1
    groupCount = ( vertexCount − 1) / groupSize + 1
} else {
    groupSize = vertexCount
    groupCount = 1
```

In some embodiments, the decoder may also use group-based decoding as a default decoding mode.

In some embodiments, when the sequence-level first syntax identification information and/or the second picture-level syntax identification information indicates group-based decoding, the decoder may also determine, by parsing the bitstream, sequence-level second syntax identification information and/or third picture-level syntax identification information. The sequence-level second syntax identification information and/or the third picture-level syntax identification information indicates the number of vertices within a group. The decoder determines the vertices in the current group based on the sequence-level second syntax identification information and/or the third picture-level syntax identification information, and then can decode the vertices in the current group in the group-based manner.

In some embodiments, the decoder may also directly parse the bitstream to determine the sequence-level second syntax identification information and/or the third picture-level syntax identification information.

In some embodiments, when the sequence-level second syntax identification information and/or the third picture-level syntax identification information is a preset identification value, the dimension syntax identification information corresponding to each coordinate dimension for the current vertex in the base mesh is determined by parsing the bitstream.

In the embodiments of the present disclosure, when the sequence-level second syntax identification information and/or the third picture-level syntax identification information is a preset identification value, the decoder decodes the base mesh in a non-grouping manner. Exemplarily, the preset identification value can be 0, or an identification value in character form. Exemplarily, the preset identification value can be set to a reserved value. The specific implementation is based on actual conditions and is not limited in the embodiments of the present disclosure.

In some embodiments, for the group-based decoding mode, the dimension syntax identification information corresponding to each of multiple coordinate dimensions for the vertex is determined by parsing the bitstream as follows. The dimension syntax identification information corresponding to each coordinate dimension for the current group is determined by parsing the bitstream; and the dimension syntax identification information corresponding to each coordinate dimension for the current group is determined as the dimension syntax identification information corresponding to each coordinate dimension for the vertex in the current group.

In some embodiments, for the non-group decoding mode, the dimension syntax identification information corresponding to each of multiple coordinate dimensions for the vertex is determined by parsing the bitstream as follows. The dimension syntax identification information corresponding to each coordinate dimension for the current vertex is determined by parsing the bitstream.

S1802: When the first picture-level syntax identification information indicates inter decoding, dimension syntax identification information corresponding to each of multiple coordinate dimensions for a vertex in the base mesh is determined by parsing the bitstream.

In the embodiments of the present disclosure, when the first picture-level syntax identification information indicates inter decoding, the decoder further parses from the bitstream the dimension syntax identification information corresponding to each of the multiple coordinate dimensions for the vertex. The dimension syntax identification information corresponding to each coordinate dimension indicates a motion-vector prediction mode corresponding to that coordinate dimension. It should be noted that, in the embodiments of the present disclosure, the dimension syntax identification information corresponding to different coordinate dimensions among the multiple coordinate dimensions may be the same or different.

In some embodiments, when the sequence-level first syntax identification information and/or the second picture-level syntax identification information indicates group-based decoding, i.e., in the case of group-based decoding, the decoder determines, by parsing the bitstream, the dimension syntax identification information corresponding to each coordinate dimension for the current group; and determines the dimension syntax identification information corresponding to each coordinate dimension for the current group as the dimension syntax identification information corresponding to each coordinate dimension for each vertex in the current group.

In some embodiments, when the sequence-level first syntax identification information and/or the second picture-level syntax identification information indicates non-group decoding, i.e., in the case of non-group decoding, the decoder determines, by parsing the bitstream, the dimension syntax identification information corresponding to each coordinate dimension for the current vertex to be decoded.

S1803: Based on the dimension syntax identification information corresponding to each of the multiple coordinate dimensions, a motion-vector decoded value corresponding to each coordinate dimension for the vertex is determined, thereby determining motion-vector decoded information corresponding to the vertex.

In the embodiments of the present disclosure, corresponding to the above encoder-side embodiments, it can be understood that the dimension syntax identification information corresponding to each coordinate dimension represents the optimal encoding mode determined according to the encoding cost(s) for that coordinate dimension. Then, the decoder can decode the bitstream data for each coordinate dimension according to the dimension syntax identification information corresponding to each coordinate dimension, using the decoding mode corresponding to the optimal encoding mode, to determine the motion-vector decoded value corresponding to each coordinate dimension for the vertex. The decoder combines the motion-vector decoded values corresponding to the multiple coordinate dimensions for the vertex to determine the motion-vector decoded information corresponding to the vertex.

In some embodiments, for each coordinate dimension, when the dimension syntax identification information corresponding to the coordinate dimension is a first value, the decoder determines, by parsing the bitstream, the motion-vector decoded value corresponding to the coordinate dimension for the vertex, thereby determining the motion-vector decoded value corresponding to each coordinate dimension for the vertex. The first value indicates that the motion-vector prediction mode corresponding to that coordinate dimension is a non-prediction mode.

Here, for each coordinate dimension, when the dimension syntax identification information corresponding to that coordinate dimension is the first value, it indicates that the motion-vector prediction mode corresponding to that coordinate dimension is the non-prediction mode. The decoder parses the bitstream in a decoding mode based on the non-prediction mode, and the obtained decoding result is the motion-vector decoded value corresponding to the vertex in the coordinate dimension.

In some embodiments, for each coordinate dimension, when the dimension syntax identification information corresponding to the coordinate dimension is the first value, the decoder performs entropy decoding on the motion-vector decoded value corresponding to the coordinate dimension for the vertex, and then performs inverse quantization and inverse transform on the decoded data to determine the motion-vector reconstructed value corresponding to the coordinate dimension for the vertex. Alternatively, the decoder performs entropy decoding on the motion-vector decoded value corresponding to the coordinate dimension for the vertex, and then performs inverse quantization or inverse transform on the decoded data to determine the motion-vector decoded value corresponding to the coordinate dimension for the vertex.

Exemplarily, when the dimension syntax identification information corresponding to the x coordinate dimension for the vertex is the first value, the decoder parses the bitstream to determine the motion-vector decoded value \hat{m}ₓ corresponding to the x coordinate dimension. When the dimension syntax identification information corresponding to the y coordinate dimension for the vertex is the first value, the decoder parses the bitstream to determine the motion-vector decoded value \hat{m}_{y} corresponding to the y coordinate dimension. When the dimension syntax identification information corresponding to the z coordinate dimension for the vertex is the first value, the decoder parses the bitstream to determine the motion-vector decoded value \hat{m}_{z} corresponding to the z coordinate dimension.

In some embodiments, for each coordinate dimension, when the dimension syntax identification information corresponding to that coordinate dimension is a second value, at least one current-picture neighbor point corresponding to the vertex in the current picture is determined according to the connectivity of the base mesh. The at least one current-picture neighbor point includes a point in the current picture that has connectivity with the vertex and has a decoding order prior to the vertex. The second value indicates that the motion-vector prediction mode corresponding to that coordinate dimension is an intra prediction mode. A first residual corresponding to the coordinate dimension for the vertex is determined by parsing the bitstream. The motion-vector decoded value corresponding to the coordinate dimension for the vertex is determined based on at least one first motion-vector reconstructed value corresponding to the at least one current-picture neighbor point and the first residual (i.e., the decoded value of the first residual), thereby determining the motion-vector decoded value corresponding to each coordinate dimension for the vertex.

Here, for each coordinate dimension, when the dimension syntax identification information corresponding to the coordinate dimension is the second value, it indicates that the motion-vector prediction mode corresponding to that coordinate dimension is the intra prediction mode. The decoder parses the bitstream, and the obtained decoding result is the first residual corresponding to the coordinate dimension for the vertex. The decoder determines an intra prediction value corresponding to the vertex based on the at least one first motion-vector reconstructed value corresponding to the at least one current-picture neighbor point, and determines the motion-vector decoded value corresponding to the coordinate dimension for the vertex based on the intra prediction value and the decoded value of the first residual corresponding to the vertex.

In some embodiments, when the dimension syntax identification information corresponding to the coordinate dimension is the second value, for each coordinate dimension, the decoder performs entropy decoding on the first residual corresponding to the coordinate dimension for the vertex, and then performs inverse quantization and inverse transform on the decoded data to determine the decoded value of the first residual corresponding to the coordinate dimension for the vertex. Alternatively, the decoder performs entropy decoding on the first residual corresponding to the coordinate dimension for the vertex, and then performs inverse quantization or inverse transform on the decoded data to determine the decoded value of the first residual corresponding to the coordinate dimension for the vertex.

In some embodiments, the motion-vector decoded value corresponding to the coordinate dimension for the vertex may be determined based on the at least one first motion-vector reconstructed value corresponding to the at least one current-picture neighbor point and the decoded value of the first residual as follows. A first motion-vector prediction value corresponding to the coordinate dimension for the vertex is determined by performing a weighted average on the at least one first motion-vector reconstructed value; and the motion-vector decoded value corresponding to the coordinate dimension for the vertex is determined based on the first motion-vector prediction value and the decoded value of the first residual. The process of the decoder determining the first motion-vector prediction value corresponding to the coordinate dimension for the vertex by performing a weighted average on the at least one first motion-vector reconstructed value is consistent with the same process in the encoder, and will not be repeated here.

Exemplarily, when the dimension syntax identification information corresponding to the x coordinate dimension for the vertex is the second value, the decoder obtains, by decoding, the decoded value of the first residual \hat{R}ₓ corresponding to the vertex in the x coordinate dimension. Based on the motion-vector prediction value p_{cx} of the vertex in the current picture and \hat{R}ₓ, the decoder determines the motion-vector decoded value \hat{m}ₓ corresponding to the x coordinate dimension for the vertex, where \hat{m}ₓ=p_{cx}+\hat{R}ₓ.

In some embodiments, the decoder may determine the motion-vector decoded value corresponding to each coordinate dimension for the vertex according to a decoding mode of a reference base mesh and the dimension syntax identification information corresponding to each coordinate dimension, where the reference base mesh is a base mesh of a reference picture corresponding to the current picture.

In some embodiments, the decoder may determine the motion-vector decoded value corresponding to each coordinate dimension for the vertex according to the decoding mode of the reference base mesh and the dimension syntax identification information corresponding to each coordinate dimension as follows.

When the decoding mode of the reference base mesh is an intra decoding mode, for each coordinate dimension: if the dimension syntax identification information corresponding to the coordinate dimension is a first value, the motion-vector decoded value corresponding to the coordinate dimension for the vertex is determined by parsing the bitstream; if the dimension syntax identification information corresponding to the coordinate dimension is a second value, at least one current-picture neighbor point corresponding to the vertex is determined in the current picture, and the first residual corresponding to the coordinate dimension for the vertex is determined; and the motion-vector decoded value corresponding to the coordinate dimension for the vertex is determined based on at least one first motion-vector reconstructed value corresponding to the at least one current-picture neighbor point and the first residual. In this way, the motion-vector decoded value corresponding to each coordinate dimension for the vertex is determined.

In the embodiments of the present disclosure, when the decoding mode of the reference base mesh is the intra decoding mode, the decoder performs the above decoding processing according to the dimension syntax identification information corresponding to each coordinate dimension to determine the motion-vector decoded value corresponding to each coordinate dimension for the vertex.

In the embodiments of the present disclosure, when the decoding mode of the reference base mesh is the intra decoding mode, the process of the decoder determining the motion-vector decoded value corresponding to the coordinate dimension for the vertex according to the dimension syntax identification information of the first value is consistent with the same process in the above embodiment, and will not be repeated here. When the decoding mode of the reference base mesh is the intra decoding mode, the process of the decoder determining the decoded value of the first residual corresponding to the coordinate dimension for the vertex according to the dimension syntax identification information of the second value, and determining the motion-vector decoded value corresponding to the coordinate dimension for the vertex based on the at least one first motion-vector reconstructed value corresponding to the at least one current-picture neighbor point and the decoded value of the first residual, is consistent with the description of the same process in the above embodiment, and will not be repeated here.

In some embodiments, the decoder may determine the motion-vector decoded value corresponding to each coordinate dimension for the vertex according to the decoding mode of the reference base mesh corresponding to the current picture and the dimension syntax identification information corresponding to each coordinate dimension as follows.

When the decoding mode of the reference base mesh is an inter decoding mode, for each coordinate dimension, if the dimension syntax identification information corresponding to the coordinate dimension is a first value, the motion-vector decoded value corresponding to the coordinate dimension for the vertex is determined by parsing the bitstream.

If the dimension syntax identification information corresponding to the coordinate dimension is a second value, at least one current-picture neighbor point corresponding to the vertex is determined in the current picture, and the first residual corresponding to the coordinate dimension for the vertex is determined by parsing the bitstream. The motion-vector decoded value corresponding to the coordinate dimension for the vertex is determined based on at least one first motion-vector reconstructed value corresponding to the at least one current-picture neighbor point and the first residual.

If the dimension syntax identification information corresponding to the coordinate dimension is a third value, at least one reference-picture neighbor point corresponding to the vertex is determined in the reference picture of the current picture, and a second residual corresponding to the coordinate dimension for the vertex is determined by parsing the bitstream. The at least one reference-picture neighbor point includes a reference vertex in the reference picture determined based on a co-located point corresponding to the vertex. The third value indicates that the motion-vector prediction mode corresponding to the coordinate dimension is an inter prediction mode. Based on at least one second motion-vector reconstructed value corresponding to the at least one reference-picture neighbor point and the second residual, the motion-vector decoded value corresponding to the coordinate dimension for the vertex is determined. In this way, the motion-vector decoded value corresponding to each coordinate dimension for the vertex is determined.

In the embodiments of the present disclosure, when the decoding mode of the reference base mesh is the inter decoding mode, for each coordinate dimension, if the dimension syntax identification information corresponding to the coordinate dimension is the first value or the second value, the process of the decoder determining the motion-vector decoded value corresponding to the coordinate dimension is consistent with the corresponding process described above, and will not be repeated here.

In the embodiments of the present disclosure, when the decoding mode of the reference base mesh is the inter decoding mode, for each coordinate dimension, if the dimension syntax identification information corresponding to the coordinate dimension is the third value, the decoder performs decoding in a decoding mode based on inter prediction. First, the decoder determines at least one reference-picture neighbor point corresponding to the vertex in the reference picture of the current picture.

In some embodiments, the decoder may determine at least one reference-picture neighbor point corresponding to the vertex in the reference picture of the current picture as follows.

In the reference picture, a reference vertex having the same index as the vertex is determined as the co-located point corresponding to the vertex. At least one of the co-located point and a reference vertex having connectivity with the co-located point in the reference picture is determined as the at least one reference-picture neighbor point.

Exemplarily, since the indices of vertices in the base mesh are the same as that of the co-located points in the reference base mesh, after determining the at least one current-picture neighbor point, the decoder may also determine a reference vertex in the reference base mesh having the same index as the at least one current-picture neighbor point as the at least one reference-picture neighbor point.

After determining the at least one reference-picture neighbor point, the decoder determines a second motion-vector prediction value corresponding to each coordinate dimension for the vertex by performing a weighted average on the at least one second motion-vector reconstructed value; and determines the motion-vector decoded value corresponding to the coordinate dimension for the vertex based on the second motion-vector prediction value and the decoded value of the second residual.

The process of the decoder determining the at least one reference-picture neighbor point, and determining the second motion-vector prediction value corresponding to each coordinate dimension for the vertex based on the at least one second motion-vector reconstructed value corresponding to the at least one reference-picture neighbor point is consistent with the same process in the encoding method of the encoder, and will not be repeated here.

Exemplarily, when the dimension syntax identification information corresponding to the x coordinate dimension for the vertex is the third value, the decoder obtains, by parsing the bitstream, the decoded value of the second residual R̅ₓ corresponding to the vertex in the x coordinate dimension. The decoder determines the motion-vector decoded value \hat{m}ₓ corresponding to the x coordinate dimension for the vertex based on the reference-frame motion-vector prediction value pᵣₓ of the vertex and R̅ₓ, where \hat{m}ₓ=pᵣₓ+R̅ₓ.

In some embodiments, for the case of non-group decoding, the decoder may decode each vertex in the base mesh using the above decoding method to determine the motion-vector decoded information corresponding to each vertex, and perform mesh reconstruction based on the motion vector information corresponding to each vertex in combination with the connectivity of the base mesh to determine reconstruction information of the base mesh. Here, the connectivity of the base mesh of the current picture is the same as the connectivity of the reference base mesh in the reference picture corresponding to the current picture, so the connectivity of the base mesh can be determined based on the known connectivity of the reference base mesh that has been decoded and reconstructed.

In some embodiments, for the case of non-group decoding, after the decoder decodes each vertex in the current group from the bitstream using the above decoding method to determines the motion-vector decoded information for each vertex in the current group, the decoder may further determine the next group among the at least one group of the base mesh according to a preset decoding order, decode the next group among the at least one group to determine the motion-vector decoded information corresponding to each vertex in the next group, until the motion-vector decoded information corresponding to each vertex in the base mesh is determined. The decoder may determine reconstruction information of the base mesh according to the motion-vector decoded information corresponding to each vertex in the base mesh in combination with the connectivity of the base mesh. The preset decoding order at the decoder is consistent with the preset encoding order at the encoder.

It can be understood that, in the embodiments of the present disclosure, the decoder can decode the vertex in each coordinate dimension according to the corresponding prediction mode based on the dimension syntax identification information corresponding to each coordinate dimension. Since the dimension syntax identification information corresponding to each coordinate dimension represents the optimal prediction mode for that coordinate dimension, decoding according to the optimal prediction mode for that dimension can improve decoding efficiency and accuracy, thereby improving decoding performance.

The following will illustrate exemplary applications of the embodiments of the present disclosure in practical application scenarios.

### Example 1

### Encoding End:

A frame (picture)-level flag (i.e., first picture-level syntax identification information) is used to indicate the encoding mode of the base mesh of each frame. For example, when the frame-level flag is 0, it indicates that the encoding mode of the base mesh of the current frame (current picture) is an inter encoding mode; when the frame-level flag is 1, it indicates that the encoding mode of the base mesh of the current frame is an intra encoding mode; when the flag is 2, it indicates that the encoding mode of the base mesh of the current frame is a skip encoding mode; 3 is a reserved value. The disclosure is not limited to this example.

When the base mesh of the current frame is in the inter encoding mode, the motion vectors of the base mesh of the current frame are encoded on a group basis according to a preset encoding order. The specific encoding method is as follows.

Encoding mode 1: For a vertex in the group, the motion vector mₓ corresponding to the x coordinate dimension, the motion vector m_{y} corresponding to the y coordinate dimension, and the motion vector m_{z} corresponding to the z coordinate dimension are encoded separately.

Encoding mode 2: According to connectivity of triangular faces in the base mesh, a current-frame neighbor point (i.e., at least one current-picture neighbor point) of the vertex in the group is determined. The current-frame neighbor point needs to satisfy: having connectivity with the vertex in the group and having an encoding order prior to the vertex in the group. A current-frame motion-vector prediction value (i.e., first motion-vector prediction value) of the vertex in the group is determined according to the motion-vector reconstructed values of the current-frame neighbor point. A difference (i.e., first residual) between the motion vector of the vertex in the group and the current-frame motion-vector prediction value in each coordinate dimension, including the difference in the x coordinate dimension mₓ−P_{cx}, the difference in the y coordinate dimension m_{y}−P_{cy}, and the difference in the z coordinate dimension m_{z}−P_{cz}, is encoded separately.

Within the group, for each dimension of x, y, and z coordinates, rate estimation values of all vertices in the group encoded using encoding mode 1 or encoding mode 2 are computed respectively. A flag (i.e., dimension syntax identification information) is used for each coordinate dimension to indicate the mode with a smaller rate cost, and this encoding mode is used to determine the encoding information of the vertices in the group.

### Decoding End:

The flag used to indicate a decoding mode of the base mesh of each frame is parsed.

When the base mesh of the current frame is in the inter decoding mode, the motion vector encoding information of the base mesh of the current frame is decoded on a group basis according to the decoding order. The specific decoding method is as follows.

A flag (i.e., dimension syntax identification information) used to indicate the decoding mode of the x, y, or z coordinate dimension of the vertices in the group is parsed. When the flag indicates non-prediction, the value parsed from the bitstream is the motion-vector decoded value of the vertices in the group in the corresponding coordinate dimension. For example, the motion-vector decoded values in the x, y, and z coordinate dimensions may be (mₓ, m_{y}, m_{z}). When the flag indicates intra prediction, the value parsed from the bitstream is the motion-vector residual decoded value (i.e., first residual decoded value) of the vertices in the group in the corresponding dimension. For example, the motion-vector residual decoded values in the x, y, and z coordinate dimensions may be (\hat{R}ₓ, \hat{R}_{y}, \hat{R}_{z}). According to the current-frame motion-vector prediction values (P_{cx}, P_{cy}, P_{cz}) of the vertex in the group, the motion-vector decoded values of each vertex can be decoded as (\hat{m}ₓ, \hat{m}_{y}, \hat{m}_{z})=(\hat{R}ₓ, \hat{R}_{y}, \hat{R}_{z})+ (P_{cx}, P_{cy}, P_{cz}).

### Example 2

### Encoding End:

A frame (picture)-level flag (i.e., first picture-level syntax identification information) is used to indicate the encoding mode of the base mesh of each frame. For example, when the frame-level flag is 0, it indicates that the encoding mode of the base mesh of the current frame (current picture) is inter encoding mode; when the frame-level flag is 1, it indicates that the encoding mode of the base mesh of the current frame is intra encoding mode; when the flag is 2, it indicates that the encoding mode of the base mesh of the current frame is skip encoding mode; 3 is a reserved bit. The disclosure is not limited to this example.

1. When the base mesh of the current frame is in inter encoding mode and the reference frame base mesh of the current frame is in intra encoding mode, the motion vectors of the base mesh of the current frame are encoded on a group basis according to a preset encoding order. The specific encoding method is as follows.

Encoding mode 1: For a vertex in the group, the motion vector mₓ corresponding to the x coordinate dimension, the motion vector m_{y} corresponding to the y coordinate dimension, and the motion vector m_{z} corresponding to the z coordinate dimension are encoded separately.

Encoding mode 2: According to connectivity of triangular faces in the base mesh, a current-frame neighbor point (i.e., current-picture neighbor point) of the vertex in the group is determined. The current-frame neighbor point needs to satisfy: having connectivity with the vertex in the group and having an encoding order prior to the vertex in the group. A current-frame motion-vector prediction value (i.e., first motion-vector prediction value) of the vertex in the group is determined according to the motion-vector reconstructed values of the current-frame neighbor point. A difference (i.e., first residual) between the motion vector of the vertex in the group and the current-frame motion-vector prediction value in each coordinate dimension, including the difference in the x coordinate dimension mₓ−P_{cx}, the difference in the y coordinate dimension m_{y}−P_{cy}, and the difference in the z coordinate dimension m_{z}−P_{cz}, is encoded separately.

Within the group, for each dimension of x, y, and z coordinates, rate estimation values of all vertices in the group encoded using encoding mode 1 or encoding mode 2 are computed respectively. A flag (i.e., dimension syntax identification information) is used for each coordinate dimension to indicate the mode with a smaller rate cost, and this encoding mode is used to determine the encoding information of the vertices in the group.

2. When the base mesh of the current frame is in inter encoding mode and the reference frame base mesh of the current frame is in inter encoding mode, the motion vectors of the base mesh of the current frame are encoded on a group basis according to the encoding order. The specific encoding method is as follows.

Encoding mode 1: For a vertex in the group, the motion vector mₓ corresponding to the x coordinate dimension, the motion vector m_{y} corresponding to the y coordinate dimension, and the motion vector m_{z} corresponding to the z coordinate dimension are encoded separately.

Encoding mode 2: According to connectivity of triangular faces in the base mesh, a current-frame neighbor point (i.e., current-picture neighbor point) of the vertex in the group is determined. The current-frame neighbor point needs to satisfy: having connectivity with the vertex in the group and having an encoding order prior to the vertex in the group. A current-frame motion-vector prediction value (i.e., first motion-vector prediction value) of the vertex in the group is determined according to the motion-vector reconstructed values of the current-frame neighbor point. A difference (i.e., first residual) between the motion vector of the vertex in the group and the current-frame motion-vector prediction value in each coordinate dimension, including the difference in the x coordinate dimension mₓ−P_{cx}, the difference in the y coordinate dimension m_{y}−P_{cy}, and the difference in the z coordinate dimension m_{z}−P_{cz}, is encoded separately.

Encoding mode 3: According to connectivity of triangular faces in the base mesh, a reference-frame neighbor point (i.e., reference-picture neighbor point) of a vertex in the group is determined. The reference-frame neighbor point needs to satisfy: being a vertex that has the same index as the current-frame neighbor point in the reference frame. A reference-frame motion-vector prediction value (i.e., second motion-vector prediction value) of the vertex in the group is determined according to the motion-vector reconstructed values of the neighbor point. A difference (i.e., first residual) between the motion vector of the vertex in the group and the reference-frame motion-vector prediction value in each coordinate dimension, including the difference in the x coordinate dimension mₓ−Pᵣₓ, the difference in the y coordinate dimension m_{y}−P_{ry}, and the difference in the z coordinate dimension m_{z}−P_{rz}, is encoded separately.

Within the group, for each dimension of x, y, and z coordinates, rate estimation values of all vertices in the group encoded using encoding mode 1, encoding mode 2, or encoding mode 3 are computed respectively. A flag (i.e., dimension syntax identification information) is used for each coordinate dimension to indicate the mode with a smaller rate cost, and this encoding mode is used to determine the encoding information of the vertices in the group.

### Decoding End:

The flag used to indicate a decoding mode of the base mesh of each frame is parsed.

When the base mesh of the current frame is in inter decoding mode, the motion vectors of the base mesh of the current frame are decoded on a group basis according to the decoding order. The specific decoding method is as follows.

1. When the base mesh of the current frame is in inter decoding mode and the reference base mesh of the reference frame of the current frame is in intra decoding mode, a flag (i.e., dimension syntax identification information) used to indicate the decoding mode of the vertices in the group is parsed, and motion vectors of the base mesh of the current frame are decoded on a group basis according to the decoding order. The specific decoding method is as follows.

When the flag indicates non-prediction, i.e., when the flag is the first value, the values parsed from the bitstream is the motion-vector decoded values (\hat{m}ₓ, \hat{m}_{y}, \hat{m}_{z}) of each vertex.

When the flag indicates intra prediction, i.e., when the flag is the second value, the values parsed from the bitstream are the motion-vector residual decoded values (\hat{R}ₓ, \hat{R}_{y}, \hat{R}_{z}) (i.e., first residual decoded values) of the vertex in the group. According to the connectivity of the triangular faces in the base mesh, the current-frame neighbor point (i.e., at least one current-picture neighbor point) of the vertex in the group is determined. The current-frame neighbor points must satisfy: having connectivity with the vertex in the group and having an encoding order prior to the vertex in the group. The current-frame motion-vector prediction values (i.e., first motion-vector prediction values) of the vertex in the group according to the motion-vector decoded values of the current-frame neighbor point. According to the current-frame motion-vector prediction values (P_{cx}, P_{cy}, P_{cz}) and motion-vector residual decoded values (\hat{R}ₓ, \hat{R}_{y}, \hat{R}_{z}) of the vertex in the group, the motion-vector decoded values of each vertex can be decoded as (\hat{m}ₓ, \hat{m}_{y}, \hat{m}_{z})=(\hat{R}ₓ, \hat{R}_{y}, \hat{R}_{z})+ (\hat{P}_{cx}, \hat{P}_{cy}, \hat{P}_{cz}).

2. When the base mesh of the current frame is in inter decoding mode and the reference base mesh of the reference frame of the current frame is in inter decoding mode, the flag (i.e., dimension syntax identification information) used to indicate the decoding mode of the vertices in the group is parsed, and motion vectors of the base mesh of the current frame are decoded on a group basis according to the decoding order. The specific decoding method is as follows.

When the flag indicates non-prediction, i.e., when the flag is the first value, the values parsed from the bitstream is the motion-vector decoded values (\hat{m}_{y}, \hat{m}_{y}, \hat{m}_{z}) of each vertex.

When the flag indicates intra prediction, i.e., when the flag is the second value, the values parsed from the bitstream are the motion-vector residual decoded values (\hat{R}ₓ, \hat{R}_{y}, R_{z}) (i.e., first residual decoded values) of the vertex in the group. According to the connectivity of the triangular faces in the base mesh, the current-frame neighbor point (i.e., at least one current-picture neighbor point) of the vertex in the group is determined. The current-frame neighbor points must satisfy: having connectivity with the vertex in the group and having an encoding order prior to the vertex in the group. The current-frame motion-vector prediction values (i.e., first motion-vector prediction values) of the vertex in the group according to the motion-vector decoded values of the current-frame neighbor point. According to the current-frame motion-vector prediction values (P_{cx}, P_{cy}, P_{cz}) and motion-vector residual decoded values (\hat{R}_{y}, \hat{R}_{y}, \hat{R}_{z}) of the vertex in the group, the motion-vector decoded values of each vertex can be decoded as (\hat{m}_{y}, \hat{m}_{y}, \hat{m}_{z})=(\hat{R}ₓ, \hat{R}_{y}, \hat{R}_{z})+ (P_{cx}, P_{cy}, P_{cz}).

When the flag indicates inter prediction, i.e., when the flag is the third value, the values parsed from the bitstream are the motion-vector residual decoded values (R̅ₓ, R̅_{y}, R̅_{z}) (i.e., second residual decoded values) of the vertex in the group. According to the connectivity of triangular faces in the base mesh, a reference-frame neighbor point (i.e., at least one reference-picture neighbor point) of the vertex in the group is determined. The reference-frame neighbor point needs to satisfy: being a vertex that has the same index as the current-frame neighbor point in the reference frame. A reference-frame motion-vector prediction value (i.e., second motion-vector prediction value) of the vertex in the group is determined according to the motion-vector reconstructed values of the neighbor point. According to the reference-frame motion-vector prediction values (P_{cx}, P_{cy}, P_{cz}) and the motion-vector residual decoded values (R̅ₓ, R̅_{y}, R̅_{z}) of the vertex in the group, the motion-vector decoded value of each vertex can be decoded as (\hat{m}ₓ, \hat{m}_{y}, \hat{m}_{z})=(R̅ₓ, R̅_{y}, R̅_{z})+ (P_{cx}, P_{cy}, P_{cz}).

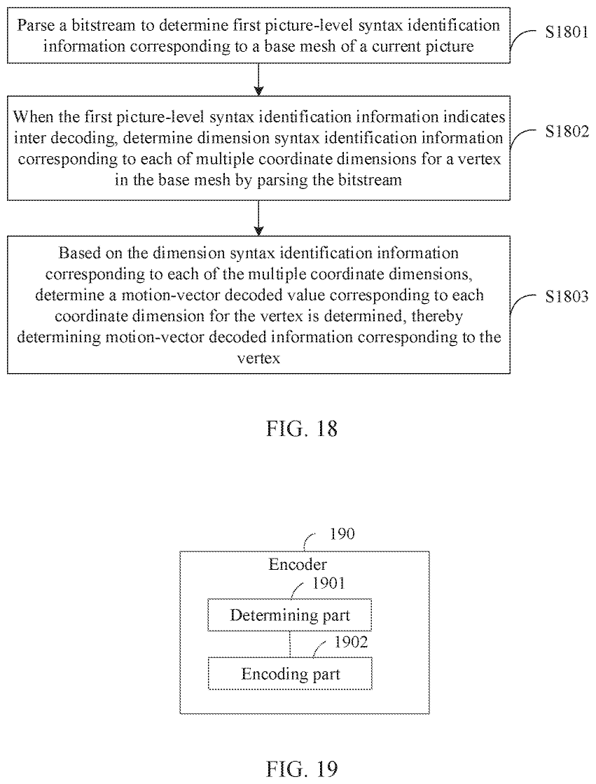

In yet another embodiment of the present disclosure, based on the same inventive concept as the foregoing embodiments, FIG. 19 illustrates a schematic diagram of a composition structure of an encoder according to an embodiment of the present disclosure. As illustrated in FIG. 19, the encoder 190 may include a determining part 1901 and an encoding part 1902.

The determining part 1901 is configured to determine a base mesh of a current picture and a motion vector corresponding to each coordinate dimension for a vertex in the base mesh.

The encoding part 1902 is configured to: when performing inter encoding on the base mesh, perform encoding cost estimation for at least one mode based on the motion vector corresponding to each coordinate dimension for the vertex, to determine at least one encoding cost for each coordinate dimension; and determine, according to the at least one encoding cost, dimension syntax identification information corresponding to each coordinate dimension for the vertex, where the dimension syntax identification information for each coordinate dimension indicates a motion-vector prediction mode corresponding to the coordinate dimension.

In some embodiments, the at least one encoding cost includes at least one of a first encoding cost and a second encoding cost. The encoding part 1902 is further configured to perform encoding cost estimation on the motion vector corresponding to each coordinate dimension for the vertex to determine the first encoding cost corresponding to each coordinate dimension for the vertex. Additionally or alternatively, the encoding part 1902 is further configured to: determine, according to connectivity of the base mesh, at least one current-picture neighbor point corresponding to the vertex in the current picture, where the at least one current-picture neighbor point includes a point in the current picture that has connectivity with the vertex and has an encoding order prior to the vertex; and perform encoding cost estimation according to at least one first motion-vector reconstructed value corresponding to each coordinate dimension for the at least one current-picture neighbor point and the motion vector corresponding to each coordinate dimension for the vertex, to determine the second encoding cost corresponding to each coordinate dimension for the vertex.

In some embodiments, the encoding part 1902 is further configured to perform encoding cost estimation for the at least one mode based on the motion vector corresponding to each coordinate dimension for the vertex and an encoding mode of a reference mesh, to determine the at least one encoding cost corresponding to each coordinate dimension for the vertex, where the reference mesh is a base mesh of a reference picture corresponding to the current picture.

In some embodiments, the at least one encoding cost includes at least one of a first encoding cost and a second encoding cost. The encoding part 1902 is further configured to: when the encoding mode of the reference mesh is an intra encoding mode, perform encoding cost estimation on the motion vector corresponding to each coordinate dimension for the vertex to determine the first encoding cost corresponding to each coordinate dimension for the vertex; and/or, perform encoding cost estimation according to at least one first motion-vector reconstructed value corresponding to each coordinate dimension for at least one current-picture neighbor point of the vertex and the motion vector corresponding to each coordinate dimension for the vertex, to determine the second encoding cost corresponding to each coordinate dimension for the vertex.

In some embodiments, the at least one encoding cost includes at least one of a first encoding cost, a second encoding cost, or a third encoding cost. The encoding part 1902 is further configured to: when the encoding mode of the reference mesh is an inter encoding mode, perform encoding cost estimation on the motion vector corresponding to each coordinate dimension for the vertex to determine the first encoding cost corresponding to each coordinate dimension for the vertex; and/or, perform encoding cost estimation according to at least one first motion-vector reconstructed value corresponding to each coordinate dimension for at least one current-picture neighbor point of the vertex and the motion vector corresponding to each coordinate dimension for the vertex, to determine the second encoding cost corresponding to each coordinate dimension for the vertex; and/or, determine at least one reference-picture neighbor point corresponding to the vertex in the reference picture, where the at least one reference-picture neighbor point includes a reference vertex determined based on a co-located point corresponding to the vertex in the reference picture, and perform encoding cost estimation according to at least one second motion-vector reconstructed value corresponding to each coordinate dimension for the at least one reference-picture neighbor point and the motion vector corresponding to each coordinate dimension for the vertex, to determine the third encoding cost corresponding to each coordinate dimension for the vertex.

In some embodiments, the encoding part 1902 is further configured to: determine a second motion-vector prediction value corresponding to each coordinate dimension for the vertex by performing a weighted average on the at least one second motion-vector reconstructed value; determine a second residual corresponding to each coordinate dimension for each vertex based on the motion vector corresponding to each coordinate dimension for the vertex and the second motion-vector prediction value; and perform encoding cost estimation on the second residual corresponding to each coordinate dimension for the vertex to determine the third encoding cost corresponding to each coordinate dimension for each vertex.

In some embodiments, the encoding part 1902 is further configured to: determine, in the reference picture, a reference vertex having a same index as each vertex as the co-located point corresponding to each vertex; and determine at least one of the co-located point or a reference vertex having connectivity with the co-located point in the reference picture as the at least one reference-picture neighbor point.

In some embodiments, the vertex in the base mesh includes a vertex in a current group among at least one group in the base mesh. The encoding part 1902 is further configured to: determine the at least one group by performing vertex grouping according to an index corresponding to each vertex in the base mesh; for each coordinate dimension, determine at least one rate estimation value and/or at least one distortion cost corresponding to the coordinate dimension for the current group by performing encoding cost estimation for the at least one mode on the motion vector corresponding to the coordinate dimension for each vertex in the current group; determine the at least one encoding cost corresponding to the coordinate dimension for the current group based on the at least one rate estimation value and/or the at least one distortion cost corresponding to the coordinate dimension for the current group, thereby determining the at least one encoding cost corresponding to each coordinate dimension for the current group; and determine, according to the at least one encoding cost corresponding to each coordinate dimension for the current group, the dimension syntax identification information corresponding to each coordinate dimension for the current group as the dimension syntax identification information corresponding to each coordinate dimension for the vertex in the current group.

In some embodiments, the vertex in the base mesh includes a current vertex in the base mesh. The at least one encoding cost for each coordinate dimension includes at least one encoding cost corresponding to each coordinate dimension for the current vertex. The encoding part 1902 is further configured to: determine, according to the at least one encoding cost corresponding to each coordinate dimension for the current vertex, at least one encoding cost corresponding to each coordinate dimension for each vertex in the base mesh; and determine, according to the at least one encoding cost corresponding to each coordinate dimension for each vertex, the dimension syntax identification information corresponding to each coordinate dimension for each vertex in the base mesh, where each vertex includes the current vertex.

In some embodiments, the encoding part 1902 is further configured to: determine sequence-level first syntax identification information and/or second picture-level syntax identification information; and when the sequence-level first syntax identification information and/or the second picture-level syntax identification information indicates group-based encoding for the base mesh, determine the at least one group by performing vertex grouping according to the index corresponding to each vertex in the base mesh.

In some embodiments, the vertex in the base mesh includes a current vertex in the base mesh. The at least one encoding cost for each coordinate dimension includes at least one encoding cost corresponding to each coordinate dimension for the current vertex. The encoding part 1902 is further configured to: when the sequence-level first syntax identification information and/or the second picture-level syntax identification information indicates no group-based encoding for the base mesh, determine, according to the at least one encoding cost corresponding to each coordinate dimension for the current vertex, at least one encoding cost corresponding to each coordinate dimension for each vertex in the base mesh; and determine, according to the at least one encoding cost for each vertex in each coordinate dimension, the dimension syntax identification information corresponding to each coordinate dimension for each vertex in the base mesh. In the above, each vertex includes the current vertex.

In some embodiments, the encoding part 1902 is further configured to: determine sequence-level second syntax identification information and/or third picture-level syntax identification information, where the sequence-level second syntax identification information and/or the third picture-level syntax identification information indicates a number of vertices within a group; and determine the vertices of the current group based on the sequence-level second syntax identification information and/or the third picture-level syntax identification information.

In some embodiments, the encoding part 1902 is further configured to: when the sequence-level first syntax identification information and/or the second picture-level syntax identification information indicates group-based encoding for the base mesh, determine the sequence-level second syntax identification information and/or the third picture-level syntax identification information.

In some embodiments, the encoding part 1902 is further configured to: when the sequence-level second syntax identification information and/or the third picture-level syntax identification information is a preset identification value, determine, according to the at least one encoding cost corresponding to each coordinate dimension for the current vertex, the dimension syntax identification information corresponding to each coordinate dimension for each vertex in the base mesh.

In some embodiments, the encoding part 1902 is further configured to, for each coordinate dimension, determine the dimension syntax identification information corresponding to the coordinate dimension for the vertex based on a smallest encoding cost among the at least one encoding cost.

In some embodiments, the encoding part 1902 is further configured to: for each coordinate dimension, when the first encoding cost is less than or equal to the second encoding cost, determine the dimension syntax identification information corresponding to the coordinate dimension for the vertex as a first value, where the first value indicates that the motion-vector prediction mode corresponding to the coordinate dimension is a non-prediction mode; and when the first encoding cost is greater than the second encoding cost, determine the dimension syntax identification information corresponding to the coordinate dimension for the vertex as a second value, where the second value indicates that the motion-vector prediction mode corresponding to the coordinate dimension is an intra prediction mode.

In some embodiments, the encoding part 1902 is further configured to: for each coordinate dimension, when a third encoding cost is less than or equal to a second encoding cost and the third encoding cost is less than or equal to a first encoding cost, determine the dimension syntax identification information corresponding to the coordinate dimension for the vertex as a third value, where the third value indicates that the motion-vector prediction mode corresponding to the coordinate dimension is an inter prediction mode; when the third encoding cost is less than or equal to the second encoding cost and the third encoding cost is greater than the first encoding cost, determine the dimension syntax identification information corresponding to the coordinate dimension for the vertex as the first value; when the third encoding cost is greater than the second encoding cost and the second encoding cost is less than or equal to the first encoding cost, determine the dimension syntax identification information corresponding to the coordinate dimension for the vertex as the second value; and when the third encoding cost is greater than the second encoding cost and the second encoding cost is greater than the first encoding cost, determine the dimension syntax identification information corresponding to the coordinate dimension for the vertex as the first value.

In some embodiments, the encoding part 1902 is further configured to: encode the motion vector corresponding to each coordinate dimension for the vertex according to the dimension syntax identification information corresponding to each coordinate dimension for the vertex, to determine motion vector encoding information corresponding to the vertex; determine first picture-level syntax identification information corresponding to the base mesh based on the motion vector encoding information corresponding to the vertex, where the first picture-level syntax identification information indicates an encoding mode corresponding to the base mesh and is used to indicate a decoding mode corresponding to the base mesh; when the first picture-level syntax identification information indicates inter encoding, generate a bitstream based on the first picture-level syntax identification information and the dimension syntax identification information corresponding to each coordinate dimension for the vertex; or, generate a bitstream based on the first picture-level syntax identification information and dimension syntax identification information corresponding to each coordinate dimension for each of at least one group in the base mesh; where the dimension syntax identification information corresponding to each coordinate dimension for each group indicates the dimension syntax identification information corresponding to each coordinate dimension for vertices in each group.

It should be noted that the description of the above device embodiments is similar to the description of the above method embodiments and has similar beneficial effects as the method embodiments. For technical details not disclosed in the device embodiments of the present invention, please refer to the description of the method embodiments of the present disclosure for understanding.

It can be understood that, in the embodiments of the present disclosure, a “part” may be a part of a circuit, a part of a processor, a part of a program or software, etc., and may also be a module, or may be non-modular. Moreover, the components in this embodiment may be integrated into one processing unit, or each unit may exist physically separately, or two or more units may be integrated into one unit. The above-mentioned integrated unit may be implemented in the form of hardware or in the form of software functional modules.

If the integrated unit is implemented in the form of a software functional module and is not sold or used as an independent product, it may be stored in a computer-readable storage medium. Based on such understanding, the technical solution of this embodiment essentially, or the part contributing to the prior art, or all or part of the technical solution may be embodied in the form of a software product. The computer software product is stored in a storage medium and includes several instructions for causing a computer device (which may be a personal computer, a server, or a network device, etc.) or a processor to perform all or part of the steps of the method described in this embodiment. The aforementioned storage medium includes: a USB flash drive, a mobile hard disk, a read-only memory (ROM), a random access memory (RAM), a magnetic disk, or an optical disk, and other media that can store program codes.

Therefore, an embodiment of the present disclosure provides a computer-readable storage medium, applied to the encoder 190. The computer-readable storage medium stores a computer program. When the computer program is executed by a first processor, the method according to any one of the foregoing embodiments is implemented.

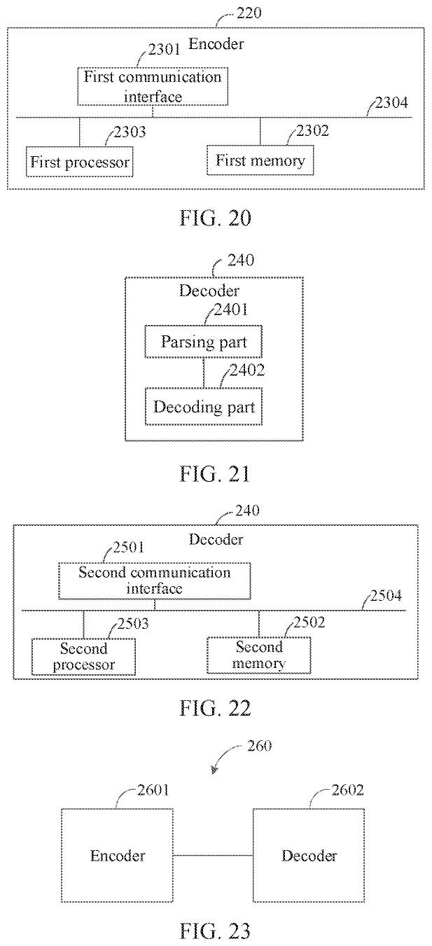

Based on the composition of the encoder 190 and the computer-readable storage medium, FIG. 20 illustrates a schematic diagram of a specific hardware structure of the encoder 190 according to an embodiment of the present disclosure. As illustrated in FIG. 23, the encoder 190 may include: a first communication interface 2301, a first memory 2302, and a first processor 2303. The various components are coupled through a first bus system 2304. It can be understood that the first bus system 2304 is used to implement connection and communication between these components. In addition to a data bus, the first bus system 2304 includes a power bus, a control bus, and a status signal bus. However, for clarity of illustration, various buses are labeled as the first bus system 2304 in FIG. 23.

The first communication interface 2301 is used for receiving and sending signals in the process of sending and receiving information with other external network elements.

The first memory 2302 is configured to store a computer program executable on the first processor 2303.

The first processor 2303 is configured to, when running the computer program, execute the encoding method applied to the encoder in the embodiments of the present disclosure.

It can be understood that the first memory 2302 in the embodiments of the present disclosure may be a volatile (transitory) memory or a non-volatile (non-transitory) memory, or may include both volatile and non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of exemplary but not limiting description, many forms of RAM are available, such as static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), synchlink dynamic random access memory (SLDRAM), and direct Rambus random access memory (DR RAM). The first memory 2302 of the systems and methods described in this disclosure is intended to include, but is not limited to, these and any other suitable types of memory.

The first processor 2303 may be an integrated circuit chip with signal processing capabilities. In the implementation process, each step of the above method may be completed by an integrated logic circuit of hardware or instructions in the form of software in the first processor 2303. The above-mentioned first processor 2303 may be a general-purpose processor, a digital signal processor (DSP), an application specific integrated circuit (ASIC), a field programmable gate array (FPGA), or other programmable logic devices, discrete gate or transistor logic devices, or discrete hardware components. It may implement or execute the methods, steps, and logic block diagrams disclosed in the embodiments of the present disclosure. A general-purpose processor may be a microprocessor or the processor may be any conventional processor or the like. The steps of the methods disclosed in conjunction with the embodiments of the present disclosure may be directly embodied as being executed and completed by a hardware decoding processor, or executed and completed by a combination of hardware and software modules in the decoding processor. The software module may be located in a random access memory, a flash memory, a read-only memory, a programmable read-only memory, or an electrically erasable programmable memory, a register, and other mature storage media in the art. The storage medium is located in the first memory 2302, and the first processor 2303 reads information from the first memory 2302 and completes the steps of the above method in combination with its hardware.

It can be understood that the embodiments described in this disclosure may be implemented in hardware, software, firmware, middleware, microcode, or a combination thereof. For hardware implementation, the processing unit may be implemented in one or more application specific integrated circuits (ASICs), digital signal processors (DSPs), digital signal processing devices (DSPDs), programmable logic devices (PLDs), field programmable gate arrays (FPGAs), general-purpose processors, controllers, microcontrollers, microprocessors, other electronic units for performing the functions described in this application, or a combination thereof. For software implementation, the technology described in this application may be implemented by modules (e.g., procedures, functions, etc.) that perform the functions described in this application. Software codes may be stored in a memory and executed by a processor. The memory may be implemented within the processor or external to the processor.

Optionally, as another embodiment, the first processor 2303 is further configured to, when running the computer program, execute the encoding method applied to the encoder according to any one of the foregoing embodiments.

Based on the same inventive concept as the foregoing embodiments, FIG. 21 illustrates a schematic diagram of a composition structure of a decoder according to an embodiment of the present disclosure. As illustrated in FIG. 21, the decoder 240 may include a parsing part 2401 and a decoding part 2402.

The parsing part 2401 is configured to: parse a bitstream to determine first picture-level syntax identification information corresponding to a base mesh of a current picture; and when the first picture-level syntax identification information indicates inter decoding, determine, by parsing the bitstream, dimension syntax identification information corresponding to each of multiple coordinate dimensions for a vertex in the base mesh; where the dimension syntax identification information corresponding to each coordinate dimension indicates a motion-vector prediction mode corresponding to the coordinate dimension.

The decoding part 2402 is configured to determine, based on the dimension syntax identification information corresponding to each of the multiple coordinate dimensions, a motion-vector decoded value corresponding to each coordinate dimension for the vertex, thereby determining motion-vector decoded information corresponding to the vertex.

In some embodiments, the decoding part 2402 is further configured to: for each coordinate dimension, when the dimension syntax identification information corresponding to the coordinate dimension is a first value, determine, by parsing the bitstream, the motion-vector decoded value corresponding to the coordinate dimension for the vertex, thereby determining the motion-vector decoded value corresponding to each coordinate dimension for the vertex; where the first value indicates that the motion-vector prediction mode corresponding to the coordinate dimension is a non-prediction mode.

In some embodiments, the decoding part 2402 is further configured to: for each coordinate dimension, when the dimension syntax identification information corresponding to the coordinate dimension is a second value, determine, according to connectivity of the base mesh, at least one current-picture neighbor point corresponding to the vertex in the current picture, where the at least one current-picture neighbor point includes a point in the current picture that has connectivity with the vertex and has a decoding order prior to the vertex; the second value indicates that the motion-vector prediction mode corresponding to the coordinate dimension is an intra prediction mode; determine, by parsing the bitstream, a first residual corresponding to the coordinate dimension for the vertex; and determine, based on at least one first motion-vector reconstructed value corresponding to the at least one current-picture neighbor point and the first residual, the motion-vector decoded value corresponding to the coordinate dimension for the vertex, thereby determining the motion-vector decoded value corresponding to each coordinate dimension for the vertex.

In some embodiments, the decoding part 2402 is further configured to: determine a first motion-vector prediction value corresponding to the coordinate dimension for the vertex by performing a weighted average on the at least one first motion-vector reconstructed value; and determine the motion-vector decoded value corresponding to the coordinate dimension for the vertex based on the first motion-vector prediction value and the first residual.

In some embodiments, the decoding part 2402 is further configured to: determine, according to a decoding mode of a reference base mesh corresponding to the current picture and the dimension syntax identification information corresponding to each coordinate dimension, the motion-vector decoded value corresponding to each coordinate dimension for the vertex.

In some embodiments, the decoding part 2402 is further configured to determine, according to a decoding mode of a reference base mesh and the dimension syntax identification information corresponding to each coordinate dimension, the motion-vector decoded value corresponding to each coordinate dimension for the vertex, where the reference base mesh is a base mesh of a reference picture corresponding to the current picture.

In some embodiments, the decoding part 2402 is further configured to, when the decoding mode of the reference base mesh is an intra decoding mode, for each coordinate dimension: if the dimension syntax identification information corresponding to the coordinate dimension is a first value, determine, by parsing the bitstream, the motion-vector decoded value corresponding to the coordinate dimension for the vertex; if the dimension syntax identification information corresponding to the coordinate dimension is a second value, determine at least one current-picture neighbor point corresponding to the vertex in the current picture, determine, by parsing the bitstream, the first residual corresponding to the coordinate dimension for the vertex, and determine the motion-vector decoded value corresponding to the coordinate dimension for the vertex based on at least one first motion-vector reconstructed value corresponding to the at least one current-picture neighbor point and the first residual, thereby determining the motion-vector decoded value corresponding to each coordinate dimension for the vertex.

In some embodiments, the decoding part 2402 is further configured to, when the decoding mode of the reference base mesh is an inter decoding mode, for each coordinate dimension: if the dimension syntax identification information corresponding to the coordinate dimension is a first value, determine, by parsing the bitstream, the motion-vector decoded value corresponding to the coordinate dimension for the vertex; if the dimension syntax identification information corresponding to the coordinate dimension is a second value, determine at least one current-picture neighbor point corresponding to the vertex in the current picture, determine, by parsing the bitstream, the first residual corresponding to the coordinate dimension for the vertex, and determine the motion-vector decoded value corresponding to the coordinate dimension for the vertex based on at least one first motion-vector reconstructed value corresponding to the at least one current-picture neighbor point and the first residual; if the dimension syntax identification information corresponding to the coordinate dimension is a third value, determine at least one reference-picture neighbor point corresponding to the vertex in the reference picture of the current picture, determine, by parsing the bitstream, a second residual corresponding to the coordinate dimension for the vertex, and determine, based on at least one second motion-vector reconstructed value corresponding to the at least one reference-picture neighbor point and the second residual, the motion-vector decoded value corresponding to the coordinate dimension for the vertex; where the at least one reference-picture neighbor point includes a reference vertex determined based on a co-located point corresponding to the vertex in the reference picture; the third value indicates that the motion-vector prediction mode corresponding to the coordinate dimension is an inter prediction mode; thereby determining the motion-vector decoded value corresponding to each coordinate dimension for the vertex.

In some embodiments, the decoding part 2402 is further configured to determine a second motion-vector prediction value corresponding to each coordinate dimension for the vertex by performing a weighted average on the at least one second motion-vector reconstructed value; and determine the motion-vector decoded value corresponding to the coordinate dimension for the vertex based on the second motion-vector prediction value and the second residual.

In some embodiments, the decoding part 2402 is further configured to determine, in the reference picture, a reference vertex having a same index as the vertex as the co-located point corresponding to the vertex; and determine at least one of the co-located point and a reference vertex having connectivity with the co-located point in the reference picture as the at least one reference-picture neighbor point.

In some embodiments, the vertex includes a vertex in a current group among at least one group in the base mesh. The decoding part 2402 is further configured to determine, by parsing the bitstream, the dimension syntax identification information corresponding to each coordinate dimension for the current group; and determine the dimension syntax identification information corresponding to each coordinate dimension for the current group as the dimension syntax identification information corresponding to each coordinate dimension for the vertex in the current group.

In some embodiments, the vertex includes a current vertex in the base mesh. The decoding part 2402 is further configured to determine, by parsing the bitstream, the dimension syntax identification information corresponding to each coordinate dimension for the current vertex.

In some embodiments, the vertex in the base mesh includes a vertex in a current group among at least one group in the base mesh. The decoding part 2402 is further configured to: determine, by parsing the bitstream, sequence-level first syntax identification information and/or second picture-level syntax identification information; and when the sequence-level first syntax identification information and/or the second picture-level syntax identification information indicates group-based decoding for the base mesh, determine, by parsing the bitstream, the dimension syntax identification information corresponding to each coordinate dimension for the current group; and determine the dimension syntax identification information corresponding to each coordinate dimension for the current group as the dimension syntax identification information corresponding to each coordinate dimension for the vertex in the current group.

In some embodiments, the vertex in the base mesh includes a current vertex in the base mesh. The decoding part 2402 is further configured to: when the sequence-level first syntax identification information and/or the second picture-level syntax identification information indicates no group-based decoding for the base mesh, determine, by parsing the bitstream, the dimension syntax identification information corresponding to each coordinate dimension for the current vertex.

In some embodiments, the decoding part 2402 is further configured to: determine, by parsing the bitstream, sequence-level second syntax identification information and/or third picture-level syntax identification information, where the sequence-level second syntax identification information and/or the third picture-level syntax identification information indicates a number of vertices within a group; and determine the vertices in the current group based on the sequence-level second syntax identification information and/or the third picture-level syntax identification information.

In some embodiments, the decoding part 2402 is further configured to: when the sequence-level first syntax identification information and/or the second picture-level syntax identification information indicates group-based decoding for the base mesh, determine, by parsing the bitstream, the sequence-level second syntax identification information and/or the third picture-level syntax identification information.

In some embodiments, the decoding part 2402 is further configured to, when the sequence-level second syntax identification information and/or the third picture-level syntax identification information is a preset identification value, determine, by parsing the bitstream, the dimension syntax identification information corresponding to each coordinate dimension for the current vertex in the base mesh.

In some embodiments, the decoding part 2402 is further configured to: decode, according to a preset decoding order, a next group among the at least one group to determine motion-vector decoded information corresponding to a vertex in the next group, until motion-vector decoded information corresponding to each vertex in the base mesh is determined; and determine reconstruction information of the base mesh according to the motion-vector decoded information corresponding to each vertex in the base mesh in combination with connectivity of the base mesh.

In some embodiments, the decoding part 2402 is further configured to: when the first picture-level syntax identification information is a third identification value, determine that the first picture-level syntax identification information indicates inter decoding.

It can be understood that, in this embodiment, a “part” may be a part of a circuit, a part of a processor, a part of a program or software, etc., and of course may also be a module, or may be non-modular. Moreover, the components in this embodiment may be integrated into one processing unit, or each unit may exist physically separately, or two or more units may be integrated into one unit. The above-mentioned integrated unit may be implemented in the form of hardware or in the form of software functional modules.

If the integrated unit is implemented in the form of a software functional module and is not sold or used as an independent product, it may be stored in a computer-readable storage medium. Based on such understanding, this embodiment provides a computer-readable storage medium, applied to the decoder 240. The computer-readable storage medium stores a computer program. When the computer program is executed by a second processor, the method according to any one of the foregoing embodiments is implemented.

It should be noted that the description of the above device embodiments is similar to the description of the above method embodiments and has similar beneficial effects as the method embodiments. For technical details not disclosed in the device embodiments of the present invention, please refer to the description of the method embodiments of the present invention for understanding.

Based on the composition of the decoder 240 and the computer-readable storage medium, FIG. 22 illustrates a schematic diagram of a specific hardware structure of the decoder 240 according to an embodiment of the present disclosure. As illustrated in FIG. 22, the decoder 240 may include: a second communication interface 2501, a second memory 2502, and a second processor 2503. The various components are coupled through a second bus system 2504. It can be understood that the second bus system 2504 is used to implement connection and communication between these components. In addition to a data bus, the second bus system 2504 includes a power bus, a control bus, and a status signal bus. However, for clarity of illustration, various buses are labeled as the second bus system 2504 in FIG. 22.

The second communication interface 2501 is used for receiving and sending signals in the process of sending and receiving information with other external network elements.

The second memory 2502 is configured to store a computer program executable on the second processor 2503.

The second processor 2503 is configured to, when running the computer program, execute the decoding method applied to the decoder provided by the embodiments of the present disclosure.

Optionally, as another embodiment, the second processor 2503 is further configured to, when running the computer program, execute the method according to any one of the foregoing embodiments.

It can be understood that the second memory 2502 has hardware functions similar to those of the first memory 2302, and the second processor 2503 has hardware functions similar to those of the first processor 2303; details are not described here again.

In yet another embodiment of the present disclosure, FIG. 23 is a schematic diagram of a composition structure of a coding system according to an embodiment of the present disclosure. As illustrated in FIG. 23, the coding system 260 may include an encoder 2601 and a decoder 2602.

In the embodiments of the present disclosure, the encoder 2601 may be the encoder according to any one of the foregoing embodiments, and the decoder 2602 may be the decoder according to any one of the foregoing embodiments.

It should be noted that, in this application, the terms “include”, “comprise” or any other variation thereof are intended to cover non-exclusive inclusion, so that a process, method, article, or device that includes a series of elements includes not only those elements but also other elements not explicitly listed, or also includes elements inherent to such process, method, article, or device. Without further limitation, an element defined by the statement “comprising a . . . ” does not exclude the presence of another identical element in the process, method, article, or device that includes the element.

The serial numbers of the above embodiments of the present disclosure are only for description and do not represent the superiority or inferiority of the embodiments.

The methods disclosed in the several method embodiments provided in this disclosure may be arbitrarily combined without conflict to obtain new method embodiments.

The features disclosed in the several product embodiments provided in this disclosure may be arbitrarily combined without conflict to obtain new product embodiments.

The features disclosed in the several method or device embodiments provided in this disclosure may be arbitrarily combined without conflict to obtain new method embodiments or device embodiments.

The above descriptions are only specific implementations of the present disclosure, but the scope of protection of the present disclosure is not limited thereto. Any person skilled in the art could easily conceive of changes or substitutions within the technical scope disclosed in the present disclosure, which shall be covered by the scope of protection of the present disclosure. Therefore, the scope of protection of the present disclosure shall be subject to the scope of protection of the claims.

### INDUSTRIAL APPLICABILITY

The embodiments of the present disclosure provide encoding and decoding methods, a bitstream, an encoder, a decoder, and a storage medium. At the encoding end, a base mesh of a current picture and a motion vector corresponding to each coordinate dimension for a vertex in the base mesh are determined. When performing inter encoding on the base mesh, encoding cost estimation for at least one mode is performed based on the motion vector corresponding to each coordinate dimension for the vertex, to determine at least one encoding cost for each coordinate dimension. According to the at least one encoding cost, dimension syntax identification information corresponding to each coordinate dimension for the vertex is determined. The dimension syntax identification information for each coordinate dimension indicates a motion-vector prediction mode corresponding to the coordinate dimension. At the decoding end, a bitstream is parsed to determine first picture-level syntax identification information corresponding to a base mesh of a current picture. When the first picture-level syntax identification information indicates inter decoding, dimension syntax identification information corresponding to each of the multiple coordinate dimensions for a vertex in the base mesh is determined by parsing the bitstream. The dimension syntax identification information corresponding to each coordinate dimension indicates a motion-vector prediction mode corresponding to the coordinate dimension. Based on the dimension syntax identification information corresponding to each of the multiple coordinate dimensions, a motion-vector decoded value corresponding to each coordinate dimension for the vertex is determined, thereby determining decoded motion-vector information corresponding to the vertex. In this way, for the motion vector corresponding to each coordinate dimension in the base mesh, an optimal coding mode corresponding to the coordinate dimension can be determined by comparing the at least one encoding cost, and the dimension coding indicator corresponding to each coordinate dimension is used to indicate to the encoder the decoding mode for that coordinate dimension, thereby improving the coding efficiency and further enhancing the coding performance.

What is claimed is:

1. A decoding method, applied to a decoder, the method comprising:
parsing a bitstream to determine first picture-level syntax identification information corresponding to a base mesh of a current picture;
when the first picture-level syntax identification information indicates inter decoding, determining, by parsing the bitstream, dimension syntax identification information corresponding to each coordinate dimension of a plurality of coordinate dimensions for a vertex in the base mesh, wherein the dimension syntax identification information corresponding to each coordinate dimension indicates a motion-vector prediction mode corresponding to the coordinate dimension; and
determining, based on the dimension syntax identification information corresponding to each coordinate dimension of the plurality of coordinate dimensions, a motion-vector decoded value corresponding to each coordinate dimension for the vertex, thereby determining motion-vector decoded information corresponding to the vertex.

2. The method according to claim 1, wherein determining, based on the dimension syntax identification information corresponding to each coordinate dimension of the plurality of coordinate dimensions, the motion-vector decoded value corresponding to each coordinate dimension for the vertex comprises:
for each coordinate dimension, when the dimension syntax identification information corresponding to the coordinate dimension is a first value, determining, by parsing the bitstream, the motion-vector decoded value corresponding to the coordinate dimension for the vertex, thereby determining the motion-vector decoded value corresponding to each coordinate dimension for the vertex, wherein the first value indicates that the motion-vector prediction mode corresponding to the coordinate dimension is a non-prediction mode.

3. The method according to claim 1, wherein determining, based on the dimension syntax identification information corresponding to each coordinate dimension of the plurality of coordinate dimensions, the motion-vector decoded value corresponding to each coordinate dimension for the vertex comprises:
for each coordinate dimension, when the dimension syntax identification information corresponding to the coordinate dimension is a second value, determining, according to connectivity of the base mesh, at least one current-picture neighbor point corresponding to the vertex in the current picture, wherein the at least one current-picture neighbor point comprises a vertex in the current picture that has connectivity with the vertex and has a decoding order prior to the vertex, and the second value indicates that the motion-vector prediction mode corresponding to the coordinate dimension is an intra prediction mode;
determining, by parsing the bitstream, a first residual corresponding to the coordinate dimension for the vertex; and
determining, based on at least one first motion-vector reconstructed value corresponding to the at least one current-picture neighbor point and the first residual, the motion-vector decoded value corresponding to the coordinate dimension for the vertex, thereby determining the motion-vector decoded value corresponding to each coordinate dimension for the vertex.

4. The method according to claim 3, wherein determining, based on the at least one first motion-vector reconstructed value corresponding to the at least one current-picture neighbor point and the first residual, the motion-vector decoded value corresponding to the coordinate dimension for the vertex comprises:
determining a first motion-vector prediction value corresponding to the coordinate dimension for the vertex by performing a weighted average on the at least one first motion-vector reconstructed value; and
determining the motion-vector decoded value corresponding to the coordinate dimension for the vertex based on the first motion-vector prediction value and the first residual.

5. The method according to claim 1, wherein determining, based on the dimension syntax identification information corresponding to each coordinate dimension of the plurality of coordinate dimensions, the motion-vector decoded value corresponding to each coordinate dimension for the vertex comprises:
determining, according to a decoding mode of a reference base mesh and the dimension syntax identification information corresponding to each coordinate dimension, the motion-vector decoded value corresponding to each coordinate dimension for the vertex, wherein the reference base mesh is a base mesh of a reference picture corresponding to the current picture.

6. The method according to claim 5, wherein determining, according to the decoding mode of the reference base mesh and the dimension syntax identification information corresponding to each coordinate dimension, the motion-vector decoded value corresponding to each coordinate dimension for the vertex comprises:
when the decoding mode of the reference base mesh is an intra decoding mode, for each coordinate dimension:
if the dimension syntax identification information corresponding to the coordinate dimension is a first value, determining the motion-vector decoded value corresponding to the coordinate dimension for the vertex by parsing the bitstream; and
if the dimension syntax identification information corresponding to the coordinate dimension is a second value, determining at least one current-picture neighbor point corresponding to the vertex in the current picture; determining, by parsing the bitstream, a first residual corresponding to the coordinate dimension for the vertex; and determining the motion-vector decoded value corresponding to the coordinate dimension for the vertex based on at least one first motion-vector reconstructed value corresponding to the at least one current-picture neighbor point and the first residual, thereby determining the motion-vector decoded value corresponding to each coordinate dimension for the vertex.

7. The method according to claim 1, wherein the vertex comprises a vertex in a current group among at least one group in the base mesh, and determining, by parsing the bitstream, the dimension syntax identification information corresponding to each coordinate dimension of the plurality of coordinate dimensions for the vertex comprises:
determining, by parsing the bitstream, the dimension syntax identification information corresponding to each coordinate dimension for the current group; and
determining the dimension syntax identification information corresponding to each coordinate dimension for the current group as the dimension syntax identification information corresponding to each coordinate dimension for the vertex in the current group.

8. The method according to claim 1, wherein the vertex comprises a current vertex in the base mesh, and determining, by parsing the bitstream, the dimension syntax identification information corresponding to each coordinate dimension of the plurality of coordinate dimensions for the vertex comprises:
determining, by parsing the bitstream, the dimension syntax identification information corresponding to each coordinate dimension for the current vertex.

9. The method according to claim 1, wherein the vertex in the base mesh comprises a vertex in a current group among at least one group in the base mesh, and the method further comprises:
determining, by parsing the bitstream, sequence-level first syntax identification information and/or second picture-level syntax identification information,
wherein when the sequence-level first syntax identification information and/or the second picture-level syntax identification information indicates group-based decoding for the base mesh, determining, by parsing the bitstream, the dimension syntax identification information corresponding to each coordinate dimension of the plurality of coordinate dimensions for the vertex in the base mesh comprises:
determining, by parsing the bitstream, dimension syntax identification information corresponding to each coordinate dimension for the current group; and
determining the dimension syntax identification information corresponding to each coordinate dimension for the current group as the dimension syntax identification information corresponding to each coordinate dimension for the vertex in the current group.

10. The method according to claim 7, further comprising:
decoding, according to a preset decoding order, a next group among the at least one group to determine motion-vector decoded information corresponding to a vertex in the next group, until motion-vector decoded information corresponding to each vertex in the base mesh is determined; and
determining reconstruction information of the base mesh according to the motion-vector decoded information corresponding to each vertex in the base mesh in combination with connectivity of the base mesh.

11. The method according to claim 1, further comprising:
when the first picture-level syntax identification information is a third identification value, determining that the first picture-level syntax identification information indicates inter decoding.

12. An encoding method, applied to an encoder, the method comprising:
determining a base mesh of a current picture and a motion vector corresponding to each coordinate dimension for a vertex in the base mesh;
when performing inter encoding on the base mesh, performing encoding cost estimation for at least one mode based on the motion vector corresponding to each coordinate dimension for the vertex, to determine at least one encoding cost corresponding to each coordinate dimension; and
determining, according to the at least one encoding cost, dimension syntax identification information corresponding to each coordinate dimension for the vertex, wherein the dimension syntax identification information for each coordinate dimension indicates a motion-vector prediction mode corresponding to the coordinate dimension.

13. The method according to claim 12, wherein the at least one encoding cost comprises at least one of a first encoding cost or a second encoding cost, and performing encoding cost estimation for the at least one mode based on the motion vector corresponding to each coordinate dimension for the vertex, to determine at least one encoding cost corresponding to each coordinate dimension comprises:
performing encoding cost estimation on the motion vector corresponding to each coordinate dimension for the vertex to determine the first encoding cost corresponding to each coordinate dimension for the vertex;
and/or,
determining, according to connectivity of the base mesh, at least one current-picture neighbor point corresponding to the vertex in the current picture, wherein the at least one current-picture neighbor point comprises a point in the current picture that has connectivity with the vertex and has an encoding order prior to the vertex; and
performing encoding cost estimation according to at least one first motion-vector reconstructed value corresponding to each coordinate dimension for the at least one current-picture neighbor point and the motion vector corresponding to each coordinate dimension for the vertex, to determine the second encoding cost corresponding to each coordinate dimension for the vertex.

14. The method according to claim 13, wherein performing encoding cost estimation according to the at least one first motion-vector reconstructed value corresponding to each coordinate dimension for the at least one current-picture neighbor point and the motion vector corresponding to each coordinate dimension for the vertex, to determine the second encoding cost corresponding to each coordinate dimension for the vertex comprises:
determining a first motion-vector prediction value corresponding to each coordinate dimension for the vertex by performing a weighted average on the at least one first motion-vector reconstructed value;
determining a first residual corresponding to each coordinate dimension for the vertex based on the motion vector and the first motion-vector prediction value corresponding to each coordinate dimension for the vertex; and
performing encoding cost estimation on the first residual corresponding to each coordinate dimension for the vertex to determine the second encoding cost corresponding to each coordinate dimension for the vertex.

15. The method according to claim 12, wherein the vertex in the base mesh comprises a vertex in a current group among at least one group in the base mesh, the at least one encoding cost corresponding to each coordinate dimension comprises at least one encoding cost corresponding to each coordinate dimension for the current group, and the method further comprises:
determining the at least one group by performing vertex grouping according to an index corresponding to each vertex in the base mesh;
wherein performing encoding cost estimation for the at least one mode based on the motion vector corresponding to each coordinate dimension for the vertex, to determine the at least one encoding cost for each coordinate dimension comprises:
for each coordinate dimension, determining at least one rate estimation value and/or at least one distortion cost corresponding to the coordinate dimension for the current group by performing encoding cost estimation for the at least one mode on the motion vector corresponding to the coordinate dimension for each vertex in the current group;
determining the at least one encoding cost corresponding to the coordinate dimension for the current group based on the at least one rate estimation value and/or the at least one distortion cost corresponding to the coordinate dimension for the current group, thereby determining the at least one encoding cost corresponding to each coordinate dimension for the current group;
wherein determining, according to the at least one encoding cost, the dimension syntax identification information corresponding to each coordinate dimension for the vertex comprises:
determining, according to the at least one encoding cost corresponding to each coordinate dimension for the current group, the dimension syntax identification information corresponding to each coordinate dimension for the current group as the dimension syntax identification information corresponding to each coordinate dimension for the vertex in the current group.

16. The method according to claim 12, wherein the vertex in the base mesh comprises a current vertex in the base mesh, the at least one encoding cost for each coordinate dimension comprises at least one encoding cost corresponding to each coordinate dimension for the current vertex, and determining, according to the at least one encoding cost, the dimension syntax identification information corresponding to each coordinate dimension for the vertex comprises:
determining, according to the at least one encoding cost corresponding to each coordinate dimension for the current vertex, at least one encoding cost corresponding to each coordinate dimension for the vertex in the base mesh; and
determining, according to the at least one encoding cost corresponding to each coordinate dimension for each vertex, the dimension syntax identification information corresponding to each coordinate dimension for each vertex in the base mesh;
wherein each vertex comprises the current vertex.

17. The method according to claim 15, further comprising:
determining sequence-level first syntax identification information and/or second picture-level syntax identification information;
wherein determining the at least one group by performing vertex grouping according to the index corresponding to each vertex in the base mesh comprises:
when the sequence-level first syntax identification information and/or the second picture-level syntax identification information indicates group-based encoding for the base mesh, determining the at least one group by performing vertex grouping according to the index corresponding to each vertex in the base mesh.

18. The method according to claim 12, wherein determining, according to the at least one encoding cost, the dimension syntax identification information corresponding to each coordinate dimension for the vertex comprises:
for each coordinate dimension, determining the dimension syntax identification information corresponding to the coordinate dimension for the vertex based on a smallest encoding cost among the at least one encoding cost.

19. The method according to claim 13, wherein determining, according to the at least one encoding cost, the dimension syntax identification information corresponding to each coordinate dimension for the vertex comprises:
for each coordinate dimension:
when the first encoding cost is less than or equal to the second encoding cost, determining the dimension syntax identification information corresponding to the coordinate dimension for the vertex as a first value, wherein the first value indicates that the motion-vector prediction mode corresponding to the coordinate dimension is a non-prediction mode; and
when the first encoding cost is greater than the second encoding cost, determining the dimension syntax identification information corresponding to the coordinate dimension for the vertex as a second value, wherein the second value indicates that the motion-vector prediction mode corresponding to the coordinate dimension is an intra prediction mode.

20. A non-transitory computer-readable storage medium having a computer program and a bitstream stored thereon, wherein the computer program, when executed by a processor, causes the processor to generate the bitstream according to an encoding method, the encoding method comprising:
determining a base mesh of a current picture and a motion vector corresponding to each coordinate dimension for a vertex in the base mesh;
when performing inter encoding on the base mesh, performing encoding cost estimation for at least one mode based on the motion vector corresponding to each coordinate dimension for the vertex, to determine at least one encoding cost corresponding to each coordinate dimension; and
determining, according to the at least one encoding cost, dimension syntax identification information corresponding to each coordinate dimension for the vertex, wherein the dimension syntax identification information for each coordinate dimension indicates a motion-vector prediction mode corresponding to the coordinate dimension.
